(19) United States
(12) Patent Application Publication
(10) Pub. No.: US 2017/0315825 A1
(43) Pub. Date: Nov. 2, 2017

(54) Presenting Contextual Content Based On Detected User Confusion

(71) Applicants: John C. Gordon, Newcastle, WA (US); Khuram Shahid, Seattle, WA (US)

(72) Inventors: John C. Gordon, Newcastle, WA (US); Khuram Shahid, Seattle, WA (US)

(21) Appl. No.: 15/144,674

(22) Filed: May 2, 2016

(51) Int. Cl. G06F 9/44; G06F 17/30; G06N 99/00

(52) U.S. Cl. CPC G06F 9/4446; G06N 99/005; G06F 17/30528; G06F 17/3053

(57) ABSTRACT

A computing platform for presenting contextual content based on detected user confusion is described. In at least one example, sensor data can be received from at least one sensor. The sensor data can be associated with measurements of at least one physiological attribute of a user. Based at least in part on the sensor data, an occurrence of an event corresponding to a confused mental state of the user can be determined. In at least one example, contextual data associated with the event can be determined. The contextual data can identify at least an application being executed at a time corresponding to the occurrence of the event. The contextual data can be leveraged to access content data for mitigating the confused mental state of the user and the content data can be presented via an output interface associated with a device corresponding to the user.

### BACKGROUND

Computing devices can generate content and present the content via user interfaces of computing devices to communicate information to users of the computing devices. In some examples, the content can include tips or tutorials on how to use an application, how to interact with a user interface, etc. Generally, applications that present such content do so upon startup of an application and the content is generalized for all users, regardless of an individual user's familiarity with the application. As a result, users are often either underwhelmed by the lack of helpful content and/or overwhelmed by the amount and/or timing of the content presentations on their computing devices. Accordingly, presented tips or tutorials are often ignored by users and as such, may not be useful and/or may not be effective in communicating important information to the user.

### SUMMARY

This disclosure describes techniques for presenting contextual content based on detected user confusion. In at least one example, sensor data can be received from at least one sensor. The sensor data can be associated with measurements of at least one physiological attribute of a user. Based at least in part on the sensor data, an occurrence of an event corresponding to a confused mental state of the user can be determined. In at least one example, contextual data associated with the event can be determined. The contextual data can identify at least an application being executed at a time corresponding to the occurrence of the event. The contextual data can be leveraged to access content data for mitigating the confused mental state of the user and the content data can be presented via an output interface of a device corresponding to the user.

The techniques described herein can leverage sensors to assess current levels of understanding associated with a user. For instance, in at least one example, the techniques described herein can analyze the sensor data to determine when a measurement associated with the sensor data appears to be uncommon for a user, and can determine that a user is confused based at least in part on detecting such an abnormality. Additionally and/or alternatively, the techniques described herein can leverage sensor data from multiple sensors to determine whether a user is confused. Based on determining that a user is confused, the techniques described herein can communicate contextual content to remediate the user confusion. The techniques described herein can conserve computing resources by refraining from arbitrarily presenting content that is not relevant and/or is not helpful to a user in view of the user's current level of understanding, and instead, can more intelligently present contextual content based on detection of a confused mental state of the user that takes into account the user's current level of understanding.

This Summary is provided to introduce a selection of concepts in a simplified form that are further described below in the Detailed Description. This Summary is not intended to identify key or essential features of the claimed subject matter, nor is it intended to be used to limit the scope of the claimed subject matter.

### BRIEF DESCRIPTION OF THE DRAWINGS

The Detailed Description is set forth with reference to the accompanying figures, in which the left-most digit of a reference number identifies the figure in which the reference number first appears. The use of the same reference numbers in the same or different figures indicates similar or identical items or features.

FIG. 1 is a schematic diagram showing an example environment for causing the presentation of contextual content based on detected user confusion.

FIG. 2 is a schematic diagram showing another example environment for causing the presentation of contextual content based on detected user confusion.

FIG. 3 is a schematic diagram showing yet another example environment for causing the presentation of contextual content based on detected user confusion.

FIG. 4 is a schematic diagram showing data flow via an example environment for causing the presentation of contextual content based on detected user confusion.

FIG. 5A is a schematic diagram showing an example of a user interface presented via a display of a device.

FIG. 5B is a schematic diagram showing an example of a user interface presented via a display of a device where contextual content is presented via the user interface.

FIG. 5C is a schematic diagram showing an example of contextual content being presented via a device.

FIG. 5D is a schematic diagram showing an example of contextual content being presented via a device.

FIG. 6 is a flow diagram that illustrates an example process to cause contextual content to be presented based on an event (i.e., user confusion).

FIG. 7 is a flow diagram that illustrates another example process to cause contextual content to be presented based on an event (i.e., user confusion).

FIG. 8 is a flow diagram that illustrates an example process to update machine learning technologies for detecting a confused mental state of a user.

FIG. 9A is a schematic diagram showing aspects of a device having sensors for tracking the movement of at least one eye of a user.

FIG. 9B is a schematic diagram showing aspects of a device having sensors for tracking the movement of at least one eye of a user.

FIG. 9C is a schematic diagram showing aspects of a device having sensors for tracking the movement of at least one eye of a user;

FIG. 10A is a schematic diagram showing an example of a device being used to calibrate one or more devices.

FIG. 10B is a schematic diagram showing another example of a device being used to calibrate one or more devices.

FIG. 10C is a schematic diagram showing yet another example of a device being used to calibrate one or more devices.

FIG. 10D is a schematic diagram showing another example of a device being used to calibrate one or more devices.

FIG. 10E is a schematic diagram showing yet another example of a device being used to calibrate one or more devices.

FIG. 10F is a schematic diagram showing another example of a device being used to calibrate one or more devices.

FIG. 11A is a schematic diagram showing an example of a device being used for tracking movement of at least one eye of a user to identify a gaze target.

FIG. 11B is a schematic diagram showing another example of a device being used for tracking movement of at least one eye of a user to identify a gaze target.

FIG. 11C is a schematic diagram showing yet another example of a device being used for tracking movement of at least one eye of a user to identify a gaze target.

FIG. 11D is a schematic diagram showing another example of a device being used for tracking movement of at least one eye of a user to identify a gaze target.

FIG. 11E is a schematic diagram showing yet another example of a device being used for tracking movement of at least one eye of a user to identify a gaze target.

FIG. 11F is a schematic diagram showing another example of a device being used for tracking movement of at least one eye of a user to identify a gaze target.

FIG. 12 is a flow diagram that illustrates an example process to identify a gaze target that is rendered on a hardware display surface or viewed through the hardware display surface.

FIG. 13 is a computer architecture diagram illustrating an illustrative computer hardware and software architecture for a computing system capable of implementing aspects of the techniques and technologies presented herein.

FIG. 14 is a diagram illustrating a distributed computing environment capable of implementing aspects of the techniques and technologies presented herein.

FIG. 15 is a computer architecture diagram illustrating a computing device architecture for a computing device capable of implementing aspects of the techniques and technologies presented herein.

### DETAILED DESCRIPTION

This disclosure describes techniques for providing contextual content via devices associated with users based on detecting user confusion. In at least one example, techniques described herein can include sensors that output sensor data associated with measurements of physiological attributes of users. For instance, in an example, the sensors can monitor physiological attributes such as the electrical resistance of the skin of a user caused by emotional stress, skin temperature, heart rate, brain activity, pupil dilation and/or contraction, eye movement, facial expressions, tone of voice (e.g., volume of speech, rate of speech, etc.), etc. Techniques described herein can leverage the sensor data to determine that a user is confused. For instance, in at least one example, the techniques described herein can analyze the sensor data to determine when a measurement associated with the sensor data appears to be uncommon for a user, and can determine that a user is confused based at least in part on detecting such an abnormality. Additionally and/or alternatively, the techniques described herein can leverage sensor data from multiple sensors to determine whether a user is confused. Based at least in part on determining that the user is confused, techniques described herein can cause the confused mental state to be communicated to a computing platform. Responsive to receiving an indication of a confused mental state, the computing platform can cause contextual content to be presented via a device associated with the user. For instance, in at least one example, the techniques described herein can cause a tip, a tutorial, or other resource to be presented via a device in an effort to remediate the confusion.

As described above, techniques described herein can include a computing platform that is configured to provide contextual content based on detecting user confusion. In at least one example, the techniques described herein can leverage models to determine which measurements associated with the sensor data indicate that a user is confused. In at least one example, the models are not specific to individual applications being executed on the computing platform. That is, the models can receive sensor data from a sensor associated with the computing platform and can determine that a user is confused. In such examples, the models may have no knowledge of the context of the confusion.

In at least one example, the techniques described herein can receive an indication that user confusion has been detected. Based at least in part on receiving an indication that user confusion has been detected, the techniques described herein can determine contextual data associated with the detected user confusion. The contextual data can indicate which application a user is interacting with when the user confusion is detected. Additionally and/or alternatively, the contextual data can indicate which feature or function associated with the application the user is interacting with when the user confusion is detected. In some examples, the contextual data can be determined based on gaze data identifying the feature or function as a gaze target. In yet other examples, the contextual data can indicate one or more actions between the user and the computing platform immediately preceding the detection of the user confusion. The techniques described herein can leverage the contextual data to access content that corresponds to the contextual data. That is, the techniques described herein can leverage the contextual data to determine the appropriate content to present in an effort to remediate the user confusion.

The techniques described herein can present the content data via various technologies. In at least one example, the contextual content can be presented as a graphical representation via a display. In some examples, the display can be a hardware display surface that can be configured to provide a real-world view of an object through the hardware display surface while also providing a rendered display of contextual content. In additional and/or alternative examples, the contextual content can be presented as spoken output, haptic output, etc., as described below.

In at least one example, the techniques described herein can cause feedback mechanisms to be presented with the contextual content. The techniques described herein can leverage feedback data determined based on user interaction with the feedback mechanism(s) to refine the models and improve the accuracy and/or precision with which the models identify when a user is confused. That is, in at least one example, the techniques described herein can receive feedback data associated with contextual content presented in association with any application executing on the computing platform and can leverage the feedback data to refine the models used for detecting user confusion.

As a non-limiting example, a user can be a new user of a messaging services application (e.g., OUTLOOK®, GMAIL®, etc.). As the user signs-on, techniques described herein can determine that the user is confused. Perhaps the user doesn't know how to set up the account or doesn't know how to set user preferences. Based at least in part on determining that the user is confused and determining what the user is confused about (e.g., setting up the account or setting user preferences), techniques described herein can cause the messaging services application to present a tip, a tutorial, or other resource to assist the user and remediate confusion. For instance, the techniques described herein can cause the messaging services application to present a widget that assists the user with setting up his or her account or setting user preferences, depending on the context. Alternatively, as another non-limiting example, a user can be an experienced user with respect to the messaging services application. The user can be trying to figure out how to change an advanced setting associated with the messaging services. The techniques described herein can determine that the user is confused. Based at least in part on determining that the user is confused and what the user is confused about, techniques described herein can cause the messaging services application to present a tip, a tutorial, or other resource to assist the user and remediate confusion. For instance, the techniques described herein can cause the application to present a widget that assists the user with changing the advanced setting.

As yet another non-limiting example, a user can be a new user of a gaming application. The user can be playing the game in an environment where real-objects and rendered objects are visible in a same view via a hardware display surface (i.e., a mixed environment), and can encounter a scenario where the techniques described herein can determine that the user is confused. For instance, the gaming application can include a first rendered obj ect and a second rendered object, which can each represent a ball, and the premise of the gaming application can be to put the balls in a basket, represented by a real-world object. Based at least in part on determining that the user is confused and what the user is confused about, techniques described herein can cause the gaming application to present a tip, a tutorial, or other resource to assist the user and remediate confusion. For instance, the techniques described herein can cause the gaming application to present a graphical representation of contextual content. The graphical representation of the contextual content can be a third rendered object that can be configured to offer a tip to mitigate any confusion associated with the gaming application. For instance, the third rendered object can be a tip instructing the user to drop the balls in the basket to earn points.

Alternatively, as another non-limiting example, a user can be an experienced user with respect to the gaming application. The user can be trying to figure out how to navigate a complex obstacle associated with an advanced level of the gaming application. The techniques described herein can determine that the user is confused. Based at least in part on determining that the user is confused and what the user is confused about, techniques described herein can cause the gaming application to present a tip, a tutorial, or other resource to assist the user and remediate confusion. For instance, the techniques described herein can cause the gaming application to present a tip that assists the user with navigating the complex obstacle.

In each non-limiting example described above, the techniques described herein can customize when to present content and/or what content is presented based on detecting confusion of the user. By leveraging detected user confusion that takes into account a user's familiarity with particular applications (e.g., the messaging services application, the gaming application, etc.) the techniques described herein prevent the experienced user from being presented with content directed to new users and/or prevent the new user from being presented with content that is directed to experienced users. The techniques described herein can conserve computing resources by refraining from arbitrarily presenting content that is not relevant and/or helpful to a user in view of the user's current level of understanding, and instead, can more intelligently present contextual content based on detection of a confused mental state of the user that takes into account the user's current level of understanding. That is, among many benefits provided by the technologies described herein, a user's interaction with a device can be improved, which can reduce the number of inadvertent inputs, reduce the consumption of processing resources, and mitigate the use of network resources. Other technical effects other than those mentioned herein can also be realized from an implementation of the technologies described herein.

It should be appreciated that the above-described subject matter can be implemented as a computer-controlled apparatus, a computer process, a computing system, or as an article of manufacture such as a computer-readable storage medium. These and various other features will be apparent from a reading of the following Detailed Description and a review of the associated drawings. Furthermore, the claimed subject matter is not limited to implementations that solve any or all disadvantages noted in any part of this disclosure.

As will be described in more detail herein, it can be appreciated that implementations of the techniques and technologies described herein can include the use of solid state circuits, digital logic circuits, computer component, and/or software executing on one or more devices. Signals described herein can include analog and/or digital signals for communicating a changed state, movement and/or any data associated with motion detection.

While the subject matter described herein is presented in the general context of program modules that execute in conjunction with the execution of an operating system and application programs on a computer system, those skilled in the art will recognize that other implementations can be performed in combination with other types of program modules. Generally, program modules include routines, programs, components, data structures, and other types of structures that perform particular tasks or implement particular abstract data types. Moreover, those skilled in the art will appreciate that the subject matter described herein can be practiced with other computer system configurations, including hand-held devices, wearable devices, multiprocessor systems, microprocessor-based or programmable consumer electronics, minicomputers, mainframe computers, and the like.

In the following detailed description, references are made to the accompanying drawings that form a part hereof, and in which are shown by way of illustration specific configurations or examples. Referring now to the drawings, in which like numerals represent like elements throughout the several figures, aspects of a computing system, computer-readable storage medium, and computer-implemented methodologies for providing contextual content in an effort to remediate detected user confusion. In at least one example, the contextual content can be provided via mixed environments, as described below. Additionally, as will be described in more detail below, there are a number of applications and services that can embody the functionality and techniques described herein.

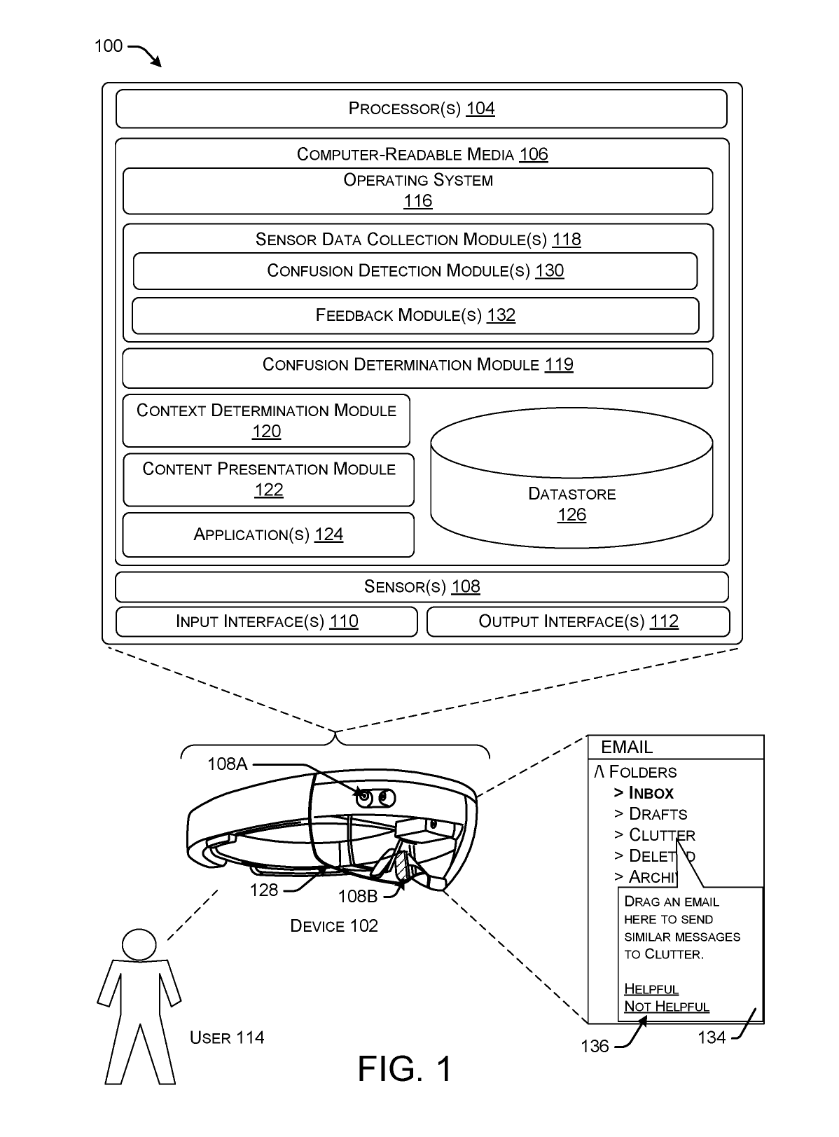

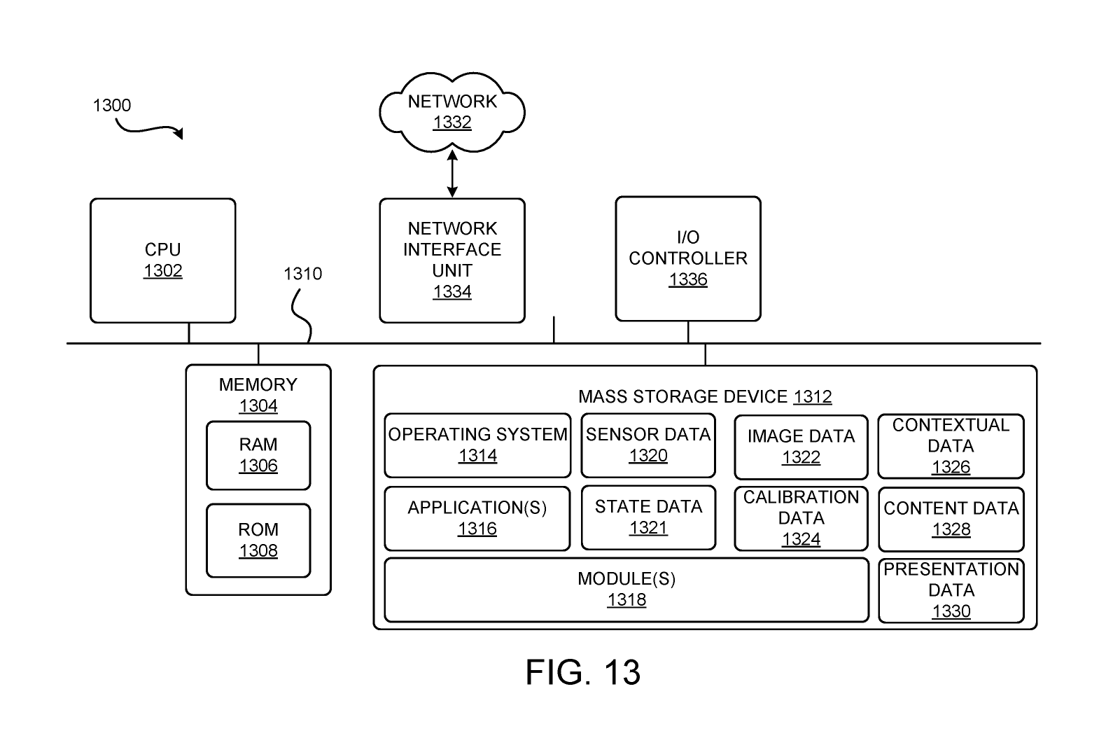

Turning to FIG. 1, FIG. 1 illustrates an example environment 100 for causing the presentation of contextual content based on detected user confusion. More particularly, the example environment 100 can include a device 102 that includes processor(s) 104, computer-readable media 106, sensor(s) 108, input interface(s) 110, and output interfaces(s) 112. Each device 102 can correspond to a user 114. In FIG. 1, device 102 is illustrated as a head-mounted device. However, device 102 can be any type of device configured to cause the presentation of contextual content based on detected user confusion. As will be described in detail, techniques described herein can involve any number of devices 102 and/or type of devices 102 configured to cause the presentation of contextual content based on detected user confusion. This example is provided for illustrative purposes and is not to be construed as limiting. Additional details associated with example environment 100 are described below with reference to FIGS. 13-15.

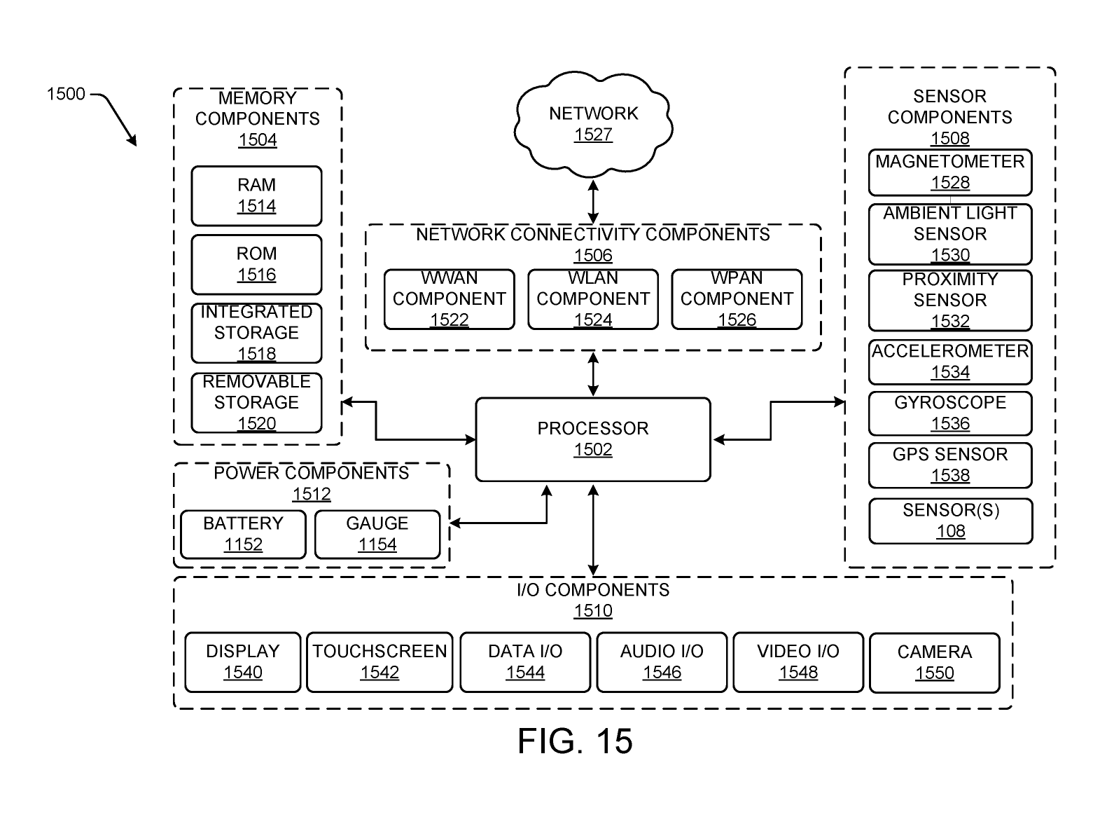

Processor(s) 104 can represent, for example, a CPU-type processing unit, a GPU-type processing unit, a field-programmable gate array (FPGA), another class of digital signal processor (DSP), or other hardware logic components that can, in some instances, be driven by a CPU. For example, and without limitation, illustrative types of hardware logic components that can be used include Application-Specific Integrated Circuits (ASICs), Application-Specific Standard Products (ASSPs), System-On-a-Chip Systems (SOCs), Complex Programmable Logic Devices (CPLDs), etc. In various examples, the processor(s) 104 can execute one or more modules and/or processes to cause the device 102 to perform a variety of functions, as set forth above and explained in further detail in the following disclosure. Additionally, each of the processor(s) 104 can possess its own local memory, which also can store program modules, program data, and/or one or more operating systems. Additional details associated with the processor(s) 104 are described below with reference to FIGS. 13 and 15.

In at least one configuration, the computer-readable media 106 of the device 102 can include components that facilitate interaction between the user 114 and the device 102. For example, the computer-readable media 106 can include an operating system 116, sensor data collection module(s) 118, a confusion determination module 119, a context determination module 120, a content presentation module 122, application(s) 124, a datastore 126, etc. While FIG. 1 illustrates the confusion determination module 119, the context determination module 120, and the content presentation module 122 as being separate from the operating system 116, in alternative examples, the confusion determination module 119, the context determination module 120, and/or the content presentation module 122 can be included in the operating system 116. That is, the operating system 116 can perform same or similar functionalities as the confusion determination module 119, the context determination module 120, and/or the content presentation module 122 in such examples.

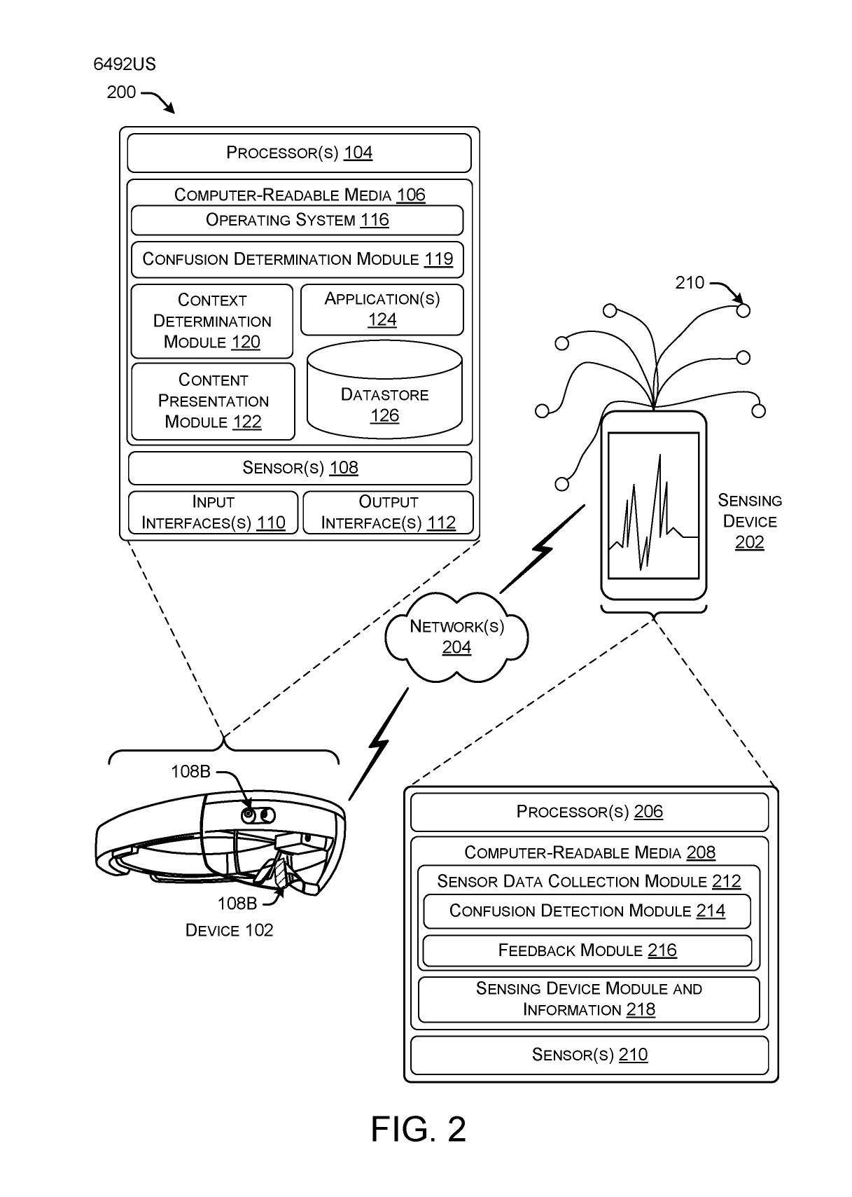

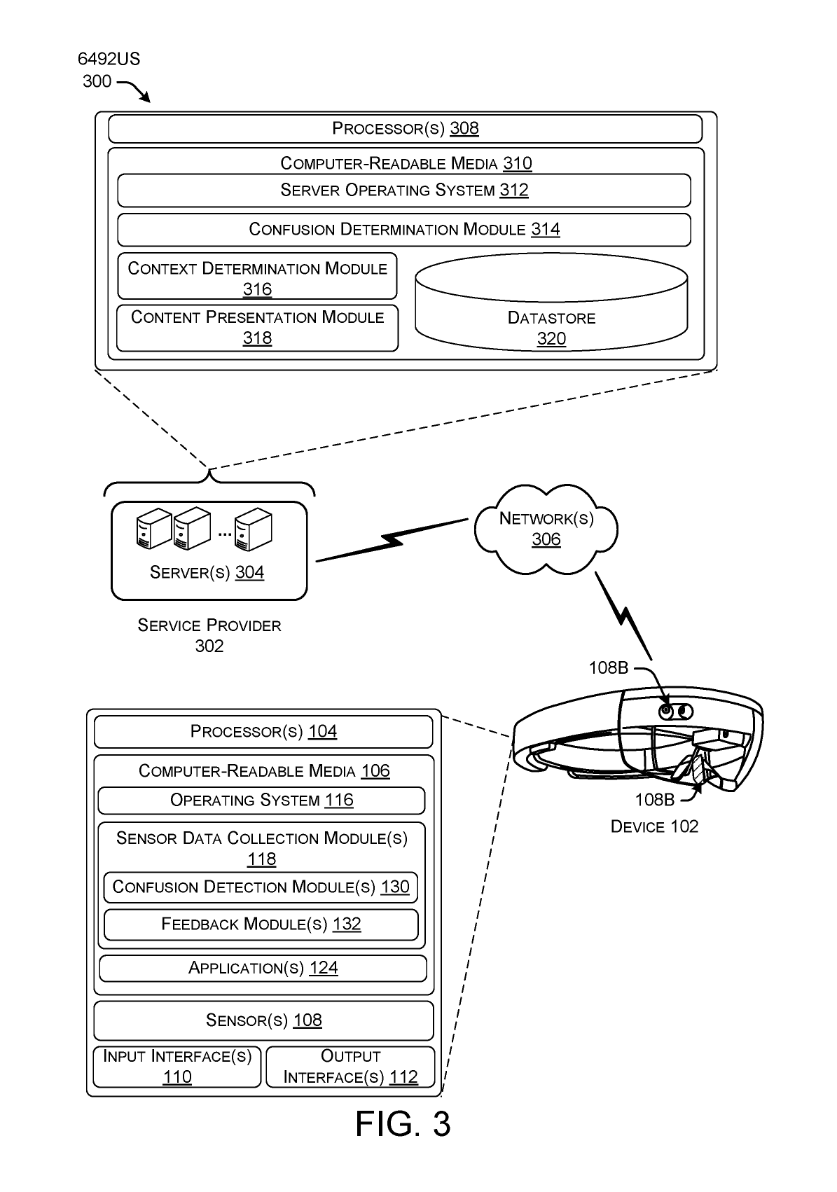

The modules can represent pieces of code executing on a computing device (e.g., device 102). In some examples, individual modules can include an interface, such as an Application Program Interface (API), to perform some or all of its functionality (e.g., operations). In additional and/or alternative examples, the components can be implemented as computer-readable instructions, various data structures, and so forth via at least one processing unit (e.g., processor(s) 104) to configure the device 102 to execute instructions and to cause contextual content to be presented via a device 102 associated with a user 114. Functionality to perform these operations can be included in multiple devices or a single device, as illustrated in FIGS. 2 and 3. Additional details associated with the computer-readable media 106 are provided below with reference to FIG. 13.

In at least one example, the sensor(s) 108 can be any device or combination of devices configured to physiologically monitor a user 114. Individual sensor(s) 108 can output sensor data to corresponding sensor data collection module(s) 118 for determining mental states associated with a user 114. The sensor(s) 108 can include, but are not limited to, a galvanic skin response sensor for measuring galvanic skin response, a skin temperature sensor for measuring the temperature on the surface of the skin, an electroencephalography (EEG) device for measuring electrical activity of the brain, an electrocardiography (ECG or EKG) device for measuring electrical activity of the heart, cameras for tracking eye movement, facial expressions, pupil dilation and/or contraction, etc., sound sensors for measuring a volume of speech, a rate of speech, etc. The sensor(s) 108 can output sensor data to the sensor data collection module(s) 118 for determining mental states associated with a user 114, as described below. The sensor data can include measurements associated with a physiological attribute of a user 114, as described below.

In additional and/or alternative examples, the sensor(s) 108 can be any device or combination of devices configured to determine a position or movement of the device 102 and other objects. For instance, the sensor(s) 108 can additionally and/or alternatively include a depth map sensor, a camera, a light field sensor, a gyroscope, a sonar sensor, an infrared sensor, a compass, an accelerometer, and/or any other device or component for detecting a position or movement of the device 102 and other objects. The sensor(s) 108 can also enable the generation of data characterizing interactions, such as user gestures, with the device 102. For illustrative purposes, the sensor(s) 108 and/or an input interface 110 can enable the generation of data defining a position and aspects of movement, e.g., speed, direction, acceleration, of one or more objects, which can include device 102, physical items near a device 102, and/or users 114. In other examples, the sensor(s) 108 and/or input interface(s) 110 can enable the generation of contextual content including tips, tutorials, and/or other resources for remediating user confusion.

FIG. 1 shows an example in which the sensor(s) 108 are part of, or built into, the device 102. More specifically, FIG. 1 shows a non-limiting example where the device 102 includes a camera sensor 108A and a galvanic skin response sensor 108B associated with a nose-bridge component of a head-mounted display. As described above, each device 102 can include any configuration of one or more sensors 108 that can be part of, or built into, the device 102. However, in alternative examples, the one or more sensors 108 can be removed, or separated, from the device 102, as illustrated and described below with reference to FIG. 2. In the alternative examples, the one or more sensors 108 can be communicatively coupled to the device 102 so that the sensor data can be communicated from the one or more sensors 108 to the device 102, for example, via a network, as illustrated in FIG. 2.

As described above, the device 102 can include the input interface(s) 110 and output interface(s) 112. The input interface(s) 110 can enable input via a keyboard, keypad, mouse, microphone, touch sensor, touch screen, joystick, control buttons, scrolling buttons, cameras, or any other device suitable to generate a signal and/or data defining a user interaction with the device 102. The output interface(s) 112 can enable the device to present data via a display (e.g., touch screen, liquid crystal display (LCD), etc.), speakers, haptic interfaces, or the like.

In at least one example, an output interface 112 can be a hardware display surface 128 that can be configured to provide a real-world view of an object through the hardware display surface 128 while also providing a rendered display of contextual content. The hardware display surface 128 can include one or more components, such as a projector, screen, or other suitable components for producing a display of an object and/or data. In some configurations, the hardware display surface 128 can be configured to cover at least one eye of a user 114. In one illustrative example, the hardware display surface 128 can include a screen configured to cover both eyes of a user 114. The hardware display surface 128 can render or cause the display of one or more images for generating a view or a stereoscopic image of one or more objects. For illustrative purposes, an object can be an item, data, device, person, place, or any type of entity. In at least one example, an object can be associated with a function or a feature associated with an application. As will be described in more detail below, some configurations enable a device 102 to graphically associate holographic user interfaces and other graphical elements with an object seen through the hardware display surface 128 or rendered objects displayed on the hardware display surface 128.

The hardware display surface 128 can be configured to allow a user 114 to view objects from different environments. In some configurations, the hardware display surface 128 can display a rendering of an object. In addition, some configurations of the hardware display surface 128 can allow a user 114 to see through selectable sections of the hardware display surface 128 having a controllable level of transparency, enabling the user 114 to view objects in his or her surrounding environment. For illustrative purposes, a user's perspective looking at objects through the hardware display surface 128 is referred to herein as a “real-world view” of an object or a “real-world view of a physical object.” As will be described in more detail below, computer generated renderings of objects and/or data can be displayed in, around, or near the selected portions of the hardware display surface 128 enabling a user to view the computer generated renderings along with real-world views of objects observed through the selected portions of the hardware display surface 128.

Some configurations described herein provide both a “see through display” and an “augmented reality display.” For illustrative purposes, the “see through display” can include a transparent lens that can have content displayed on it. The “augmented reality display” can include an opaque display that is configured to display content over a rendering of an image, which can be from any source, such as a video feed from a camera used to capture images of an environment. For illustrative purposes, some examples described herein describe a display of rendered content over a display of an image. In addition, some examples described herein describe techniques that display rendered content over a “see through display” enabling a user to see a real-world view of an object with the content. It can be appreciated that the examples of the techniques described herein can apply to a “see through display,” an “augmented reality display,” or variations and combinations thereof. For illustrative purposes, devices configured to enable a “see through display,” “augmented reality display,” or combinations thereof are referred to herein as devices that are capable of providing a “mixed environment” display.

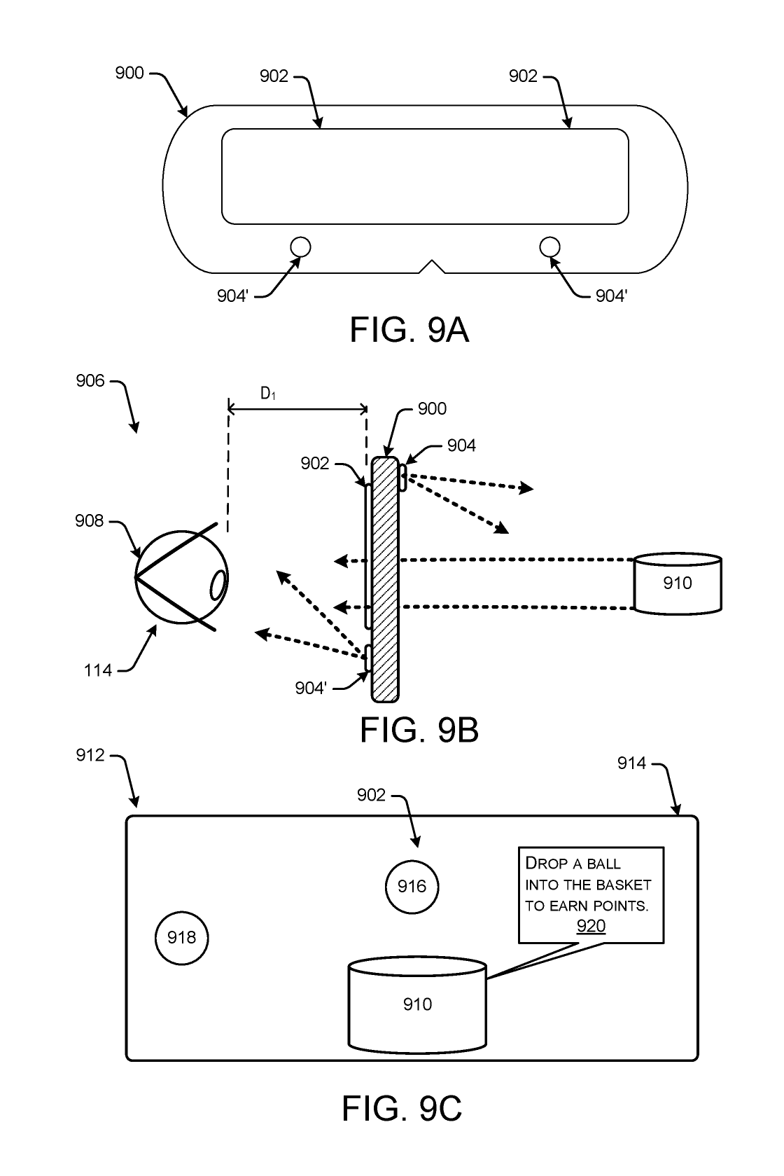

Additional details associated with the hardware display surface 128 are described below with reference to FIGS. 9A-9C, 10A-10F, and 11A-11F. Additional details associated with the input interface(s) 110 and/or the output interface(s) 112 are described below with reference to FIGS. 13 and 15.

As described above, the computer-readable media 106 of the device 102 can include components that facilitate interaction between the user 114 and the device 102. The operating system 116 can be configured to manage hardware and services within and coupled to the device 102 for the benefit of other components and/or modules. As further described herein, the sensor data collection module(s) 118 can include confusion detection module(s) 130 and feedback module(s) 132. In at least one example, the sensor data collection module(s) 118 can receive data from corresponding sensor(s) 108, and the confusion detection module(s) 130 can determine a confused mental state of a user 114. Corresponding feedback module(s) 132 can receive feedback data that can be used for improving the accuracy and/or precision of the confusion detection module(s) 130. The confusion determination module 119 can receive data generated from sensor data output from one or more sensors that indicates a likelihood that a user 114 is confused, and can utilize the data to make a determination as to whether the user 114 is confused. The context determination module 120 can be configured to receive instructions from the operating system 116 to initiate a process for accessing content based at least in part on detecting the confused mental state associated with the user 114 and causing the content to be presented. Additionally, the context determination module 120 can determine contextual data associated with the detection of the confused mental state of the user 114. The context determination module 120 can be configured to send instructions to the content presentation module 122 and/or the application(s) 124 to present content via an output interface 112 of the device 102.

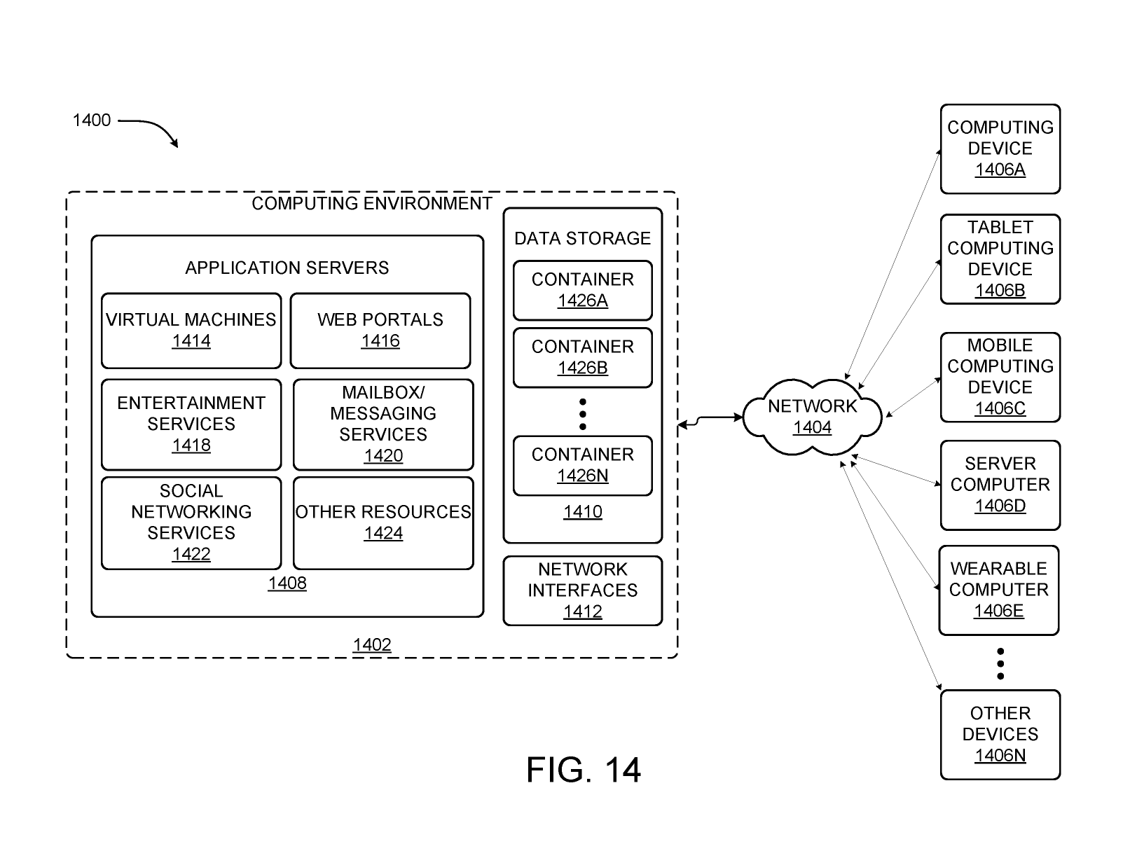

The device 102 can include application(s) 124 that are stored in the computer-readable media 106 or otherwise accessible to the device 102. In at least one example, applications (e.g., application(s) 124) can be created by programmers to fulfill specific tasks and/or perform specific functionalities. For example, applications (e.g., application(s) 124) can provide utility, entertainment, educational, and/or productivity functionalities to users 114 of devices 102. Applications (e.g., application(s) 124) can be built into a device (e.g., telecommunication, text message, clock, camera, etc.) or can be customized (e.g., games, news, transportation schedules, online shopping, etc.). Additional details associated with application(s) 124 are described below with reference to FIG. 14.

The datastore 126 can store data that is organized so that it can be accessed, managed, and updated. In at least one example, the datastore 126 can store logs associated with activities performed by the device 102. For instance, the logs can indicate application(s) 124 running on the device 102 at various times, application statuses associated with the application(s) 124, what data individual applications of the application(s) 124 are accessing, crashes associated with the application(s) 124, actions taken with respect to the application(s) 124 and/or the device 102, etc. Additionally and/or alternatively, the datastore 126 can store logs associated with the operating system 116, software and/or hardware running on the device 102, incoming and/or outgoing device traffic, etc. The data stored in the datastore 126 can be updated at a particular frequency, in predetermined intervals, after a lapse of a predetermined amount of time, responsive to an occurrence of an event (e.g., new activity, etc.), etc.

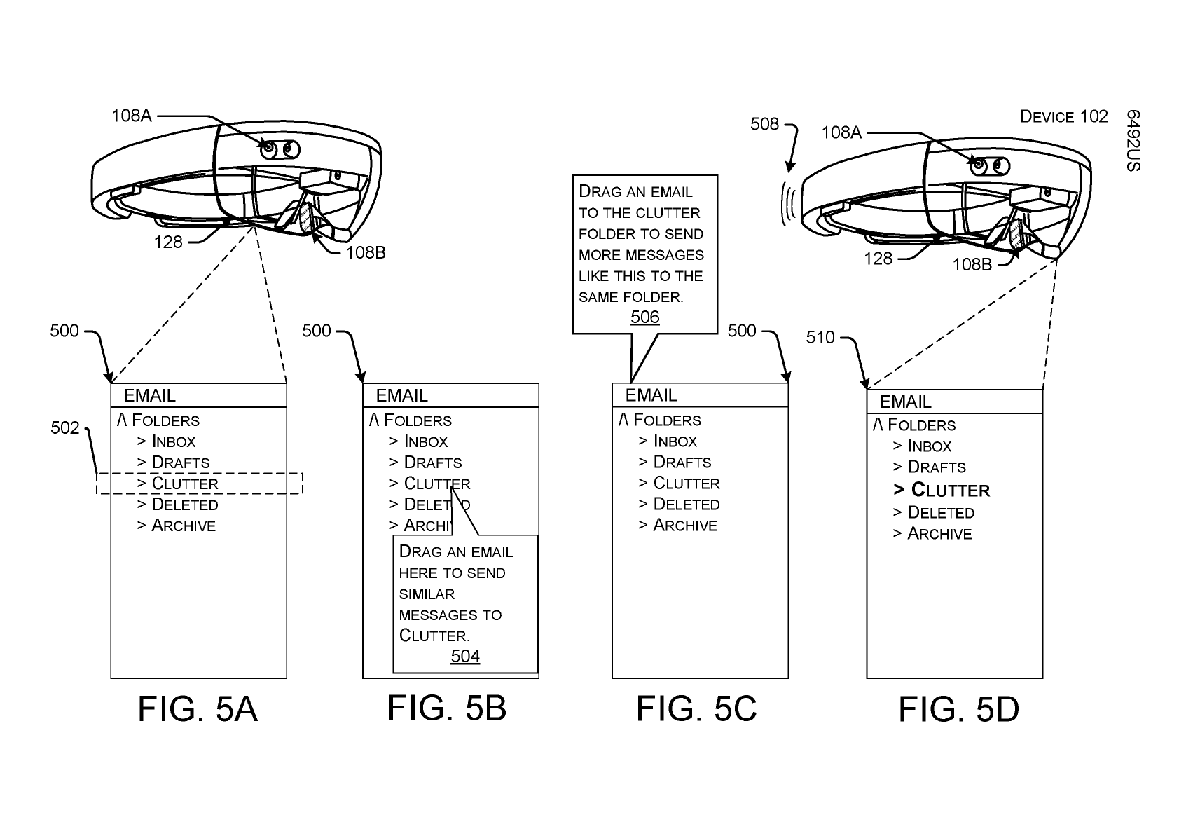

As described above, the content presentation module 122 and/or the application(s) 124 can present content via an output interface 112 of the device 102. FIG. 1 illustrates a non-limiting example of a graphical representation 134 of content that can be presented via a display 128 of the device 102. The graphical representation 134 can include a mechanism 136 for providing feedback (i.e., a feedback mechanism), as described herein. As described above, in at least one example, the output interface 112 can be a hardware display surface 128 that can be configured to provide a real-world view of an object through the hardware display surface while also presenting the graphical representation 134. In an alternative and/or additional example, the content presentation module 122 can cause the content to be presented as spoken language output via a speaker associated with the device 102. In yet other examples, the content presentation module 122 can cause the content to be presented via haptic response output by the device 102. Additional details associated with presenting content are described below with reference to FIGS. 5A-5D, 9A-9C, and 11A-11F.

FIG. 2 illustrates an example environment 200 for causing the presentation of contextual content based on detected user confusion. As described above, FIG. 1 shows an example where the sensor(s) 108 are part of, or built into, the device 102. However, in alternative examples, the one or more sensors can be removed, or separated, from a device, as illustrated in FIG. 2. In FIG. 2, a sensing device 202 can be communicatively coupled to device 102 so that the sensor data can be presented from the sensing device 202 to the device 102, for example, via one or more networks 206.

The sensing device 202 can be any device or combination of devices configured to physiologically monitor a user 114, as described above in the context of the sensor(s) 108 in FIG. 1. In some examples, the sensing device 202 can include processor(s) 206, computer-readable media 208, and sensor(s) 210. In such examples, the processor(s) 206 can have a same composition and functionality as processor(s) 104, the computer-readable media 208 can have a same composition and functionality as computer-readable media 106, and sensor(s) 210 can have a same composition and functionality as of the sensor(s) 108, described above. The sensor(s) 210 can output sensor data to the sensor data collection module 212 associated with the sensing device 202. The sensor data collection module 212 can have a same composition and functionality as the sensor data collection module(s) 118, described above. The sensor data collection module 212 can include a confusion detection module 214 and a feedback module 216, both modules that can have the same composition and functionality as the confusion detection module 130 and the feedback module 132, respectively, as described above. Additionally, the computer-readable media 208 can include sensing device module and information 218 configured to manage hardware and services within and coupled to the sensing device 202 for the benefit of other components and/or modules.

The network(s) 204 can facilitate communication between the sensing device 202 and the device 102. In some examples, the network(s) 204 can be any type of network known in the art, such as the Internet. Moreover, device 102 and/or sensing device 202 can communicatively couple to the network(s) 204 in any manner, such as by a global or local wired or wireless connection (e.g., local area network (LAN), intranet, etc.). In addition, device 102 and/or sensing device 202 can communicate using any other technology such as BLUETOOTH, WI-FI, WI-FI DIRECT, NFC, or any other suitable light-based, wired, or wireless technology. It should be appreciated that many more types of connections can be utilized than are illustrated in FIG. 2. Additional details associated with the network(s) 204 are described below with reference to FIGS. 13-15.

FIG. 3 illustrates an example environment 300 for causing the presentation of contextual content based on detected user confusion. More particularly, the example environment 300 can include a service provider 302 including one or more servers 304 that are communicatively coupled to the device 102, for example, via one or more networks 306.

The service provider 302 can be any entity, server(s), platform, etc., that facilitates generating and causing content to be presented via a device 102 based at least in part on detected user confusion. The service provider 302 can be implemented in a non-distributed computing environment or can be implemented in a distributed computing environment, possibly by running some modules on device 102 or other remotely located devices. In an example, the service provider 302 can be configured to receive an indication of an event. For illustrative purposes, an event can correspond to a detection of a confused mental state. The service provider 302 can determine contextual data associated with the event and can cause content data corresponding to the contextual data to be presented via a device 102 communicatively coupled to the service provider 302.

As shown, the one or more servers 304 can include one or more processor(s) 308 and computer-readable media 310, such as memory. Examples support scenarios in which device(s) that can be included in the one or more servers 304 can include one or more computing devices that operate in a group or other clustered configuration to share resources, balance load, increase performance, provide fail-over support or redundancy, or for other purposes. As described above, device(s) that can be included in the one or more servers 304 can include any type of computing device having processor(s) 308 operably connected to computer-readable media 310 such as via a bus, which in some instances can include one or more of a system bus, a data bus, an address bus, a PCI bus, a Mini-PCI bus, and any variety of local, peripheral, and/or independent buses. Executable instructions stored on computer-readable media 310 can include, for example, a server operating system 312, a confusion determination module 314, a context determination module 316, a content presentation module 318, a datastore 320, and other modules, programs, or applications that are loadable and executable by the processor(s) 308. In such examples, the processor(s) 308 can have a same composition and functionality as processor(s) 104 and the computer-readable media 310 can have a same composition and functionality as computer-readable media 106, described above. The server operating system 312 can be configured to manage hardware and services within and coupled to the server(s) 304 for the benefit of other components and/or modules described herein. The confusion determination module 314, the context determination module 316, the content presentation module 318, and the datastore 320 can each have a same composition and functionality, respectively, as the confusion determination module 119, the context determination module 120, the content presentation module 122, and the datastore 126 described herein.

Alternatively, or in addition, the functionality described herein can be performed, at least in part, by one or more hardware logic components such as accelerators. For example, and without limitation, illustrative types of hardware logic components that can be used include Field-Programmable Gate Arrays (FPGAs), Application-Specific Integrated Circuits (ASICs), Application-Specific Standard Products (AS SPs), System-On-a-Chip systems (SOCs), Complex Programmable Logic Devices (CPLDs), etc. The one or more servers 304, which can be associated with different service providers 302, can also include components, such as the components shown in FIG. 15, for executing one or more aspects of the techniques described herein.

While FIG. 3 illustrates that the confusion determination module 314, the context determination module 316, the content presentation module 318, and the datastore 320 can be located remotely from the device 102, any of the components (e.g., sensor(s) 108, sensor data collection module(s) 118, confusion detection module 130, feedback module 132, application(s) 124, etc.) can be located remotely from the device 102 and can be communicatively coupled to the device 102 via one or more networks 306.

The network(s) 306 can facilitate communication between the service provider 302 and the device 102. In some examples, the network(s) 306 can be any type of network known in the art, such as the Internet. Moreover, device 102 and/or service provider 302 can communicatively couple to the network(s) 306 in any manner, such as by a global or local wired or wireless connection (e.g., local area network (LAN), intranet, etc.). In addition, device 102 and/or service provider 302 can communicate using any other technology such as BLUETOOTH, WI-FI, WI-FI DIRECT, NFC, or any other suitable light-based, wired, or wireless technology. It should be appreciated that many more types of connections can be utilized than are illustrated in FIG. 3. Additional details associated with the network(s) 306 are described below with reference to FIGS. 13-15.

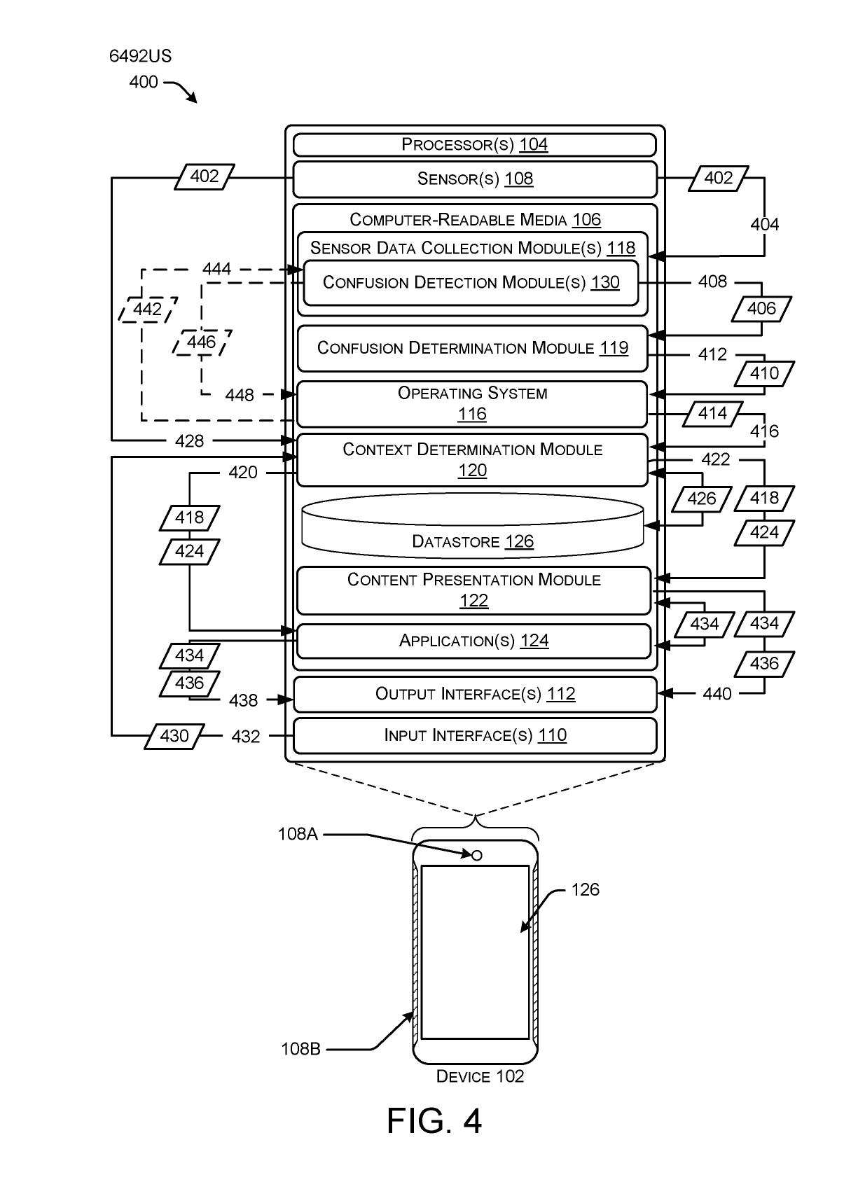

Turning to FIG. 4, FIG. 4 illustrates data flow via an example environment 400 for causing the presentation of contextual content based on detected user confusion. FIG. 4 illustrates device 102 with one or more components omitted for the purpose of clarity.

In at least one example, the sensor data collection module(s) 118 can receive sensor data 402 from the sensor(s) 108, as represented by line 404. In at least one example, each sensor data collection module of the sensor data collection module(s) 118 can be a driver corresponding to an individual sensor of the sensor(s) 108. As described above, the sensor data 402 can include, but is not limited to, measurements associated with galvanic skin response, skin temperature, electrical activity of the brain, electrical activity of the heart, eye movement, facial expressions, pupil dilation and/or contraction, a volume of speech, a rate of speech, etc. As a non-limiting example, a camera sensor can track the eye movement associated with a user 114 and provide sensor data 402 corresponding to a measurement of eye movement. Or, in another non-limiting example, an EEG sensor can determine measurements associated with electrical activity of the brain and can provide sensor data 402 indicating such. Or, as another non-limiting example, a sound sensor can analyze speech input (e.g., a user 114 talking to a personal assistant) to determine a volume associated with the speech input and/or the rate of the speech input. The volume associated with the speech input and/or the rate of the speech input can be associated with the sensor data 402 provided to a corresponding sensor data collection module 118.

In at least one example, each sensor data collection module of the sensor data collection module(s) 118 can include one or more modules that can analyze the sensor data 402 received from a corresponding sensor 108 to determine a mental state associated with a user 114. As described above, for each sensor of the one or more sensors 108, a corresponding confusion detection module 130 can be configured to determine that a user 114 is confused based at least in part on the sensor data 402 received from the sensor 108. In at least one example, the confusion detection module 130 can include one or more machine learning technologies for detecting a confused mental state of the user 114. The term “machine learning” can refer to one or more programs that learns from the data it receives. For example, a machine learning mechanism can build, modify or otherwise utilize a data model that is created from example inputs and makes predictions or decisions using the data model. In the current example, the machine learning mechanism can be used to detect a confused mental state associated with a user 114. The data model can be trained using supervised learning algorithms (e.g., artificial neural networks, Bayesian statistics, support vector machines, decision trees, classifiers, k-nearest neighbor, etc.), unsupervised learning algorithms (e.g., artificial neural networks, association rule learning, hierarchical clustering, cluster analysis, etc.), semi-supervised learning algorithms, deep learning algorithms, etc.

In some examples, the data model can be generic such that it has been trained on a data set of sensor data collected from a general population. In such examples, a measurement that indicates a confused mental state can be determined based on a value of central tendency (e.g., mean, median, etc.) of measurements associated with the general population. In other examples, the data model can be specific to a user 114 such that they have been trained on a data set of sensor data specific to the user 114. In such examples, a measurement that indicates a confused mental state can be determined based on a value of central tendency (e.g., mean, median, etc.) of measurements associated with the user 114. In additional and/or alternative examples, the data model can be tailored to a user 114. That is, in such examples, the data model can be trained on a data set of sensor data collected from a general population initially and can be refined based at least in part on receiving feedback from a user 114 that indicates whether the user 114 was experiencing the mental state determined by the confusion detection module 130. In response to updating the data model based on feedback data, the data model can more accurately and/or precisely identify sensor data 402 that indicates that the user 114 is confused.

In at least one example, the confusion detection module 130 can access the sensor data 402 received from a corresponding sensor 108 and can determine that a user 114 is confused based at least in part on determining that the sensor data 402 indicates a measurement that exceeds a predetermined threshold associated with a state of confusion. The predetermined threshold can be specific to a user 114 or generic for a population of users 118, as described above. Alternatively, the confusion detection module 130 can access the sensor data 402 received from a corresponding sensor 108 and can determine that a user 114 is confused based at least in part on determining that the sensor data 402 indicates a measurement that is less than a predetermined threshold associated with a state of non-confusion. The predetermined threshold can be specific to a user 114 or generic for a population of users 118, as described above. In other examples, the confusion detection module 130 can access the sensor data 402 received from a corresponding sensor 108 and can determine that a user 114 is confused based at least in part on determining that the sensor data 402 indicates a measurement that is within a predetermined range of measurements associated with a state of confusion. The predetermined range of measurements can be specific to a user 114 or generic for a population of users 118, as described above.

In at least one example, the confusion detection module 130 can determine a probability between zero and one that is indicative of the likelihood that a user 114 is confused based at least in part on measurements associated with the sensor data 402. For instance, as a non-limiting example, the confusion detection module 130 can determine that, based at least in part on the measurements associated with the sensor data 402, that the likelihood that the user 114 is confused is .85. Alternatively, the confusion detection module 130 can determine a percentage that is indicative of a degree of confusion of a user 114 based at least in part on measurements associated with the sensor data 402. For instance, as a non-limiting example, the confusion detection module 130 can determine that a user 114 is 90% confused. In such examples, a percentage closer to 0% can represent less confusion than a percentage that is closer to 100%. The percentages can be specific to a user 114 or generic for a population of users 118.

In at least one example, the confusion determination module 119 can receive state data 406 from one or more confusion detection modules 130, as represented by line 408. For illustrative purposes, state data 406 can be associated with a value that is indicative of a confused mental state of a user 114. For instance, state data 406 can include a probability, a percentage, etc., as described above. In such examples, state data 406 can be associated with a reliability value that can indicate a likelihood that the state data 406 is accurate. In at least one example, the confusion determination module 119 can rank the state data 406 received from the one or more confusion detection modules 130 based at least in part on the reliability value.

In at least one example, the confusion determination module 119 can determine that a user 114 is confused based at least in part on analyzing combinations of state data 406. As a non-limiting example, the confusion determination module 119 can determine that a user 114 is confused based at least in part on state data 406 derived from a combination of eye movement measurements received from a camera sensor and state data 406 derived from measurements of electrical activity of the brain received from an EEG. In at least one example, the confusion determination module 119 can include one or more machine learning technologies for determining the confused mental state of the user 114 based at least in part on combinations of state data 406. As described above, the term “machine learning” can refer to one or more programs that learns from the data it receives. In the current example, a machine learning mechanism can be used to determine a confused mental state associated with a user 114 based at least in part on state data 406 received from one or more confusion detection modules 130. The data model can be trained using supervised learning algorithms (e.g., artificial neural networks, Bayesian statistics, support vector machines, decision trees, classifiers, k-nearest neighbor, etc.), unsupervised learning algorithms (e.g., artificial neural networks, association rule learning, hierarchical clustering, cluster analysis, etc.), semi-supervised learning algorithms, deep learning algorithms, etc.

The data model can output a value that indicates that a user 114 is confused that is determined based at least in part on one or more weighted signals. In at least one example, state data 406 received from a confusion detection module 130 can correspond to a signal. In at least one example, each signal can correspond to a different sensor of the sensor(s) 108. That is, each signal can represent a value indicative of a likelihood that a user 114 is confused that can be derived from sensor data 402 output from a different sensor. Each signal can be associated with a weight in the data model, as described above. As an example, a signal associated with first state data 406 received from a first confusion detection module 130 associated with a first sensor data collection module 118, which corresponds to a first sensor 108, can be associated with a first weight, and a signal associated with second state data 406 received from a second confusion detection module 130 associated with a second sensor data collection module 118, which corresponds to a second sensor, can be associated with a second weight. In at least one example, the weights can be assigned to signals based at least in part on the reliability measures associated with the corresponding state data 406. As a non-limiting example, a signal corresponding to state data 406 associated with a reliability measure above a threshold can have a largest weight and a signal corresponding to state data 406 associated with a reliability measure below the threshold can have a lowest weight. In some examples, the weights can be assigned based at least in part on a position in a ranking, described above. That is, a signal corresponding to a top raking state data 406 can have a highest weight and a signal corresponding to a bottom ranking state data 406 can have a lowest weight. The weights can be modified based at least in part on the feedback, as described above.

In some examples, the data model can be generic such that it has been trained on a data set state data collected from a general population. In such examples, a value that indicates a confused mental state can be determined based on a value of central tendency (e.g., mean, median, etc.) of values associated with the general population. In other examples, the data model can be specific to a user 114 such that they have been trained on a data set of state data specific to the user 114. In such examples, a value that indicates a confused mental state can be determined based on a value of central tendency (e.g., mean, median, etc.) of values associated with the user 114. In additional and/or alternative examples, the data model can be tailored to a user 114. That is, in such examples, the data model can be trained on a data set of state data collected from a general population initially and can be refined based at least in part on receiving feedback from a user 114 that indicates whether the user 114 was experiencing the mental state determined by the confusion determination module 119. In response to updating the data model based on feedback data, the data model can more accurately and/or precisely identify state data that indicates that the user 114 is confused.

In at least one example, the confusion determination module 119 can be configured to receive additional and/or alternative data and the data model can be trained to leverage the additional and/or alternative data to determine whether a user 114 is confused. For instance, the confusion determination module 119 can receive data indicating keywords identified in speech input that can be used to determine that a user 114 is confused. For instance, such data can identify words such as “I'm so confused,” “This is so frustrating!” or “ugh” and the confusion determination module 119 can leverage such words to determine that the user 114 is confused. Moreover, as described above, the confusion determination module 119 can receive feedback from the user 114 to iteratively refine the data model by optimizing the weights associated with each of the signals, as described above.

Based at least in part on determining that a user 114 is confused, the confusion determination module 119 can send event data 410 to the operating system 116, as represented by line 412. In at least one example, the event data 410 can indicate that the confusion determination module 119 has determined that the user 114 is confused. In at least one example, the confusion determination module 119 can be associated with an interface (e.g., an API) that is configured to receive the state data 406 and transmit the event data 410 to the operating system 116. As described above, the operating system 116 can be configured to manage hardware and services within and coupled to the device 102 for the benefit of other components and/or modules. In at least one example, the operating system 116 can send notification data 414 to the context determination module 120, as represented by line 416. In at least one example, the operating system 116 can be associated with an interface (e.g., an API) that is configured to receive the event data 410 and transmit notification data 414 to the context determination module 120. The notification data 414 can include instructions to initiate accessing content data and causing the content data to be presented via the device 102.

As described above, the context determination module 120 can be configured to receive the notification data 414 from the operating system 116. The context determination module 120 can be configured to send command data 418 including instructions to output content data via an output interface 112 of the device 102. In some examples, the context determination module 120 can send command data 418 to the application that the user 114 was interacting with when the confusion detection module 130 detected a confused mental state, as represented by line 420. In other examples, the context determination module 120 can send command data 418 to the content presentation module 122, as represented by line 422.

In at least one example, the context determination module 120 can send contextual data 424 indicating contextual information with the command data 418. The context determination module 120 can determine contextual data 424 associated with the event data 410. The contextual data 424 can indicate an application, a feature, a function, etc. that the user 114 was interacting with, or one or more actions taken by the user 114, at substantially the same time, or immediately preceding, the determination of the confused mental state. For illustrative purposes, substantially the same time can refer to a time that is the same as the time that the confusion detection module 130 detected the confused mental state or a time within a threshold distance of the time that the confusion detection module 130 detected the confused mental state.

In at least one example, the context determination module 120 can access the datastore 126 to access data 426 corresponding to logs associated with activities performed by the device 102. As described above, the logs can indicate application(s) 124 running on the device 102 at various times, application statuses associated with the application(s) 124, what data individual applications of the application(s) 124 are accessing, crashes associated with the application(s) 124, actions taken with respect to the application(s) 124 and/or the device 102, etc. The context determination module 120 can analyze the logs to determine which application of the application(s) 124 the user 114 was interacting with just prior to or at a substantially same time that the event data 410 was generated. For instance, the context determination module 120 can determine which application of the application(s) 124 was in focus at or near the time that the event data 410 was generated.

Additionally and/or alternatively, the context determination module 120 can leverage sensor data 402 received from the sensor(s) 108, as represented by line 428, and/or input data 430 received from the input interface(s) 110 to determine a feature and/or a function of the application that the user 114 was interacting with at or near the time the event data 410 was generated, as represented by line 432. For instance, the context determination module 120 can determine a region of a user interface corresponding to a feature where a mouse was positioned for a period of time that exceeds a threshold period of time. Or, the context determination module 120 can determine a feature on a user interface associated with an application presented via a touch screen that a user 114 touched at or near the time the event data 410 was generated.

Furthermore, in some examples, the context determination module 120 can receive gaze data associated with sensor data 402 to determine a feature and/or a function of the application that the user 114 was interacting with at or near the time the event data 410 was generated. In at least one example, the sensor(s) 108 and/or input interface(s) 110 can enable the generation of gaze data identifying an object that a user 114 is looking at, which is also referred to herein as a “gaze target.” In some configurations, a gaze target can be identified by the use of sensor(s) 108 and/or input interface(s) 110 enabling the generation of gaze data identifying a direction in which a user is looking, which is also referred to herein as a “gaze direction.” For example, a sensor 108, such as a camera or depth map sensor, mounted to a device 102 can be directed towards a user's field of view. The context determination module 120 can analyze gaze data generated from the sensor(s) 108 and/or input interface(s) 110 to determine if an object in the field of view is in a pre-determined position or area of an image of the image data. If an object is positioned within a pre-determined area of at least one image, such as the center of the image, the context determination module 120 can determine that the object is a gaze target.

Other types of sensor(s) 108 and/or other data can be utilized to identify a gaze target and a gaze direction. For instance, a compass, positioning tracking component (e.g., a GPS component), and/or an accelerometer can be used to generate data indicating a gaze direction and data indicating the location of a particular object. Using such data, the techniques described herein can determine that the particular object is a gaze target. Other data, such as data indicating a speed and direction in which an object is moving can also be used to identify a gaze direction and/or a gaze target.

In some configurations, sensor(s) 108 can be directed toward at least one eye of a user 114. Gaze data indicating the direction and/or position of at least one eye can be used to identify a gaze direction and a gaze target. Such configurations can be used when a user 114 is looking at a rendering of an object displayed on a hardware display surface 128. In one illustrative example, if an head mounted display device (e.g., device 102) worn by a user 114 has two distinct objects rendered on the hardware display surface 128, the sensor(s) 108 directed toward at least one eye of a user 114 can enable the generation of gaze data indicating if the user is looking at the first rendered object or the second rendered object. Additional details of a configuration having sensor(s) 108 directed toward at least one eye of a user 114 are provided below in reference to FIGS. 9A-9C, 10A-10F, and 11A-11F. Such configurations can be used with other techniques described herein to enable a device 102 to identify a gaze target.

As a non-limiting example, a user 114 can be interacting with a document in a mixed environment. The context determination module 120 can analyze gaze data can identify to determine if the user 114 is looking at a particular section of the document. For example, if a user is holding a paper print of a file or looking at a rendering of a file, the context determination module 120 can interpret the contents of the file and a section of the document that the user 114 was interacting with when user confusion was detected (i.e., at substantially the same time as the event data 410 was generated).

In some examples, the context determination module 120 can determine one or more actions that occurred prior to the generation of the event data 410. In at least one example, the context determination module 120 can access the data 426 corresponding to the logs stored in the datastore 126, as described above. The context determination module 120 can analyze the logs to determine one or more actions performed preceding the time that the event data 410 was generated. In at least one example, the one or more actions can be associated with various application(s) 124. As a non-limiting example, a user 114 can be editing photos stored in a photo storage application of the application(s) 124 using an editing application of the application(s) 124. That is, the user 114 can be switching back and forth between the photo storage application and the editing application. The logs can indicate that the user 114 is switching back and forth between the photo storage application and the editing application. The context determination module 120 can leverage this information to determine that the user 114 is using the photo editing function of the editing application (instead of a music or video editing function associated with the editing application). That is, the context determination module 120 can determine contextual data 424 based at least in part on system-level context including but not limited to, what a user 114 was previously interacting with, previous actions between the user 114 and one or more applications 124 of the computing device 102, etc.

As described above, in some examples, the context determination module 120 can send command data 418 to the application that the user 114 was interacting with when the confusion detection module 130 detected user confusion, as represented by line 420. Responsive to receiving the command data 418, the application can access or generate content data 434. Content data 434, as described above, can include tips, tutorials, or other resources that are intended to mitigate the confusion of the user 114. In some examples, the content data 434 can be previously defined content that corresponds to the contextual data 424 determined by the context determination module 142. That is, in at least one example, programmers associated with the application can define content data 434 that should be rendered based on a determination of user confusion in association with a particular application, function, feature, preceding action(s), etc. Previously defined content data 434 can include, for example, XML or other user interface definitions that define what content should be rendered when confusion is detected. The previously defined content data 434 can be stored in a repository of previously defined content data 434 and can be accessed by the application based on receiving command data 418. In other examples, the content data 434 can be generated based on a series of events. In such examples, the application can present a programmer with a series of events to trigger arbitrary call execution and enable the programmer to write custom handlers based on the series of events. As a non-limiting example, the programmer can register with the operating system 116 so that when confusion is detected in a particular situation, the operating system 116 can call a specified method in an application to identify appropriate content data 434 or programmatically generate the content data 434 responsive to the call.

In at least one example, the application can leverage the contextual data 424 to determine the appropriate content data 434 to provide to the user 114. For instance, if the contextual data 424 identifies a feature or a function that is likely the source of confusion, the application can determine whether content data 434 is available to remediate confusion corresponding to the feature or the function. Based at least in part on determining that there is content data 434 available to remediate confusion corresponding to the feature or the function, the application can send the content data 434 to the content presentation module 122 and/or directly to the output interface(s) 112. Based at least in part on determining that there is not any content data 434 available to remediate confusion corresponding to the feature or the function, the application can fall back to content data 434 that is available for a container associated with the feature or the function. Based at least in part on determining that there is content data 434 available for the container associated with the feature or the function, the application can send the content data 434 to the content presentation module 122 and/or directly to the output interface(s) 112. Based at least in part on determining that there is not any content data 434 available for the container associated with the feature or the function, the application can fall back to content data 434 that is available for a container associated with the application. Based at least in part on determining that there is content data 434 available for the application, the application can send the content data 434 to the content presentation module 122 and/or directly to the output interface(s) 112. In at least one example, based at least in part on determining that there is not any content data 434 available for the application, the application can request content data from an application programmer, initiate a search, access content that is available at the operating system level, etc.

In at least one example, the application can determine a presentation of the content data 434 via the device 102 and can send the content data 434 and presentation data 436 to the output interface(s) 112, as represented by line 438. The presentation data 436 can include, for example, instructions regarding how to present the content data 434. In such examples, the application can cause the content data 434 to be output via an output interface 112 of the device 102, as described above. In such examples, the application can determine how the content data 434 should be presented via the device 102. That is, the application can determine an optimal output based on the contextual data 424 and/or user preferences. For illustrative purposes, an optimal output can be an output of content that is least disruptive to a user 114, given the determined context. As a non-limiting example, the application can be a gaming application and accordingly, the application can cause a graphical representation associated with content data 434 to be presented in an inconspicuous location on the display 128, a spoken representation of the content data 434 to be presented via a speaker, etc., to limit the distraction to the user 114. In some examples, the application can leverage user preferences in determining the optimal output.

In alternative examples, the application can send the content data 434 to the content presentation module 122, as represented by line 422, and the content presentation module 122 can determine how the content data 434 should be presented via the device 102. Alternatively, the context determination module 120 can send command data 418 to the content presentation module 122, as represented by line 422, and the content presentation module 122 can access the content data 434 from the application and determine how the content data 434 should be presented via the device 102. In such examples, the content presentation module 112 can determine an optimal output based on the contextual data 424 and/or user preferences. As a non-limiting example, the content presentation module 112 can determine that a user 114 is playing a video game associated with a gaming application and accordingly, can cause a graphical representation associated with content data 434 to be presented in an inconspicuous location on the display 128, a spoken representation of the content data 434 to be presented via a speaker, etc. to limit the distraction to the user 114. In such examples, the content presentation module 122 can send the content data 434 and presentation data 436 to the output interface(s) 112, as represented by line 440. That is, the content presentation module 122 can cause the content data 434 to be output via an output interface 112 of the device 102, as described above. In some examples, the content presentation module 122 can leverage user preferences in determining the optimal output.

In an alternative implementation, the operating system 116 can send queries 442 to poll the confusion detection module 130, as represented by dashed line 444. In such examples, the operating system 116 can send queries 442 at a particular frequency, after a lapse of a predetermined period of time with no user input, etc. The confusion detection module 130 can send query responses 446 indicating whether a user 114 is determined to be confused or how confused a user 114 is at the time of the query 436, as represented by dashed line 448. For instance, based at least in part on receiving a query 424, the confusion detection module 130 can send a query response 440 indicating that the user 114 is 40% confused, 80% confused, etc. In an example, a series of query responses 446 can be monitored until the operating system 116 determines that a user 114 is confused (e.g., the percentage exceeds a threshold, falls within a range, etc.), at which point the operating system 116 can send notification data 404 to the context determination module 120, as described above. In other examples, the query responses 446 can be cached and can be accessible by the application(s) 124 for modifying the application(s) 124. For instance, the application(s) 124 can access a series of query responses 446 over a period of time to track an overall level of confusion associated with the period of time and can leverage the series of query responses 446 for making improvements to individual application(s) 124, etc.

FIG. 5A illustrates an example of a user interface 500 presented via a display of a device 102. As a non-limiting example, the user interface 500 can be associated with a mailing services application (e.g., GMAIL®, OUTLOOK®, etc.). In at least one example, the confusion detection module 130 can determine that sensor data generated by a sensor, e.g., camera sensor 108A and/or galvanic skin response sensor 108B, indicates that a user 114 is confused, as described above. The content determination module 120 can determine that the user 114 was interacting with the mailing services application and, more specifically, based at least in part on gaze data and/or other input data, can determine that the user 114 was focused on the clutter folder shown in box 502, as described above. For instance, perhaps the clutter folder was recently added and an experienced user can not figure out how to use it, and accordingly, the user's 114 gaze is fixated such that the clutter folder corresponds to a gaze target. As described above, based at least in part on detecting that the user 114 is confused and identifying what the user 114 is confused about, the content presentation module 122 and/or the application(s) 124 can present contextual content to a user 114 via an output interface 112 of the device 102.

FIG. 5B illustrates an example of a graphical representation 504 of content data that can be output via the display of the device 102. As described above, the content presentation module 122 and/or the application(s) 124 can determine a position of the graphical representation 504 on the user interface 500. In some examples, the graphical representation 504 can be positioned proximate to, or within a threshold distance of, the feature or function that is the source of confusion. In other examples, the graphical representation 504 can be positioned in another location to avoid disrupting user interaction with the user interface 500. In at least one example, the content presentation module 122 and/or the application(s) 124 can leverage user preferences to determine a position of the graphical representation on the user interface 500.

FIG. 5C illustrates an example of a spoken representation 506 of the content data that can be presented via speakers associated with a device 102. As described above, in at least one example, the content presentation module 122 can cause the content to be presented as spoken language output via a speaker associated with the device 102. In such examples, a speaker can output a spoken representation of the content data. FIG. 5D illustrates an example of a tactile representation 508 of the content data that can be presented via a haptic interface associated with a device 102. As described above, in at least one example, the content presentation module 122 can cause a tactile representation of the content data to be presented via haptic interfaces associated with the device 102, as described above. A haptic interface can correspond to a tactile interface that can output force, vibration, motion, etc. to present context data. In some examples, the haptic output can be associated with a change to a user interface. For instance, in FIG. 5D, the clutter folder appears bold and in larger font in user interface 510 as compared to its appearance in user interface 500. The font change can occur at substantially the same time as the haptic output (e.g., tactile representation 508).

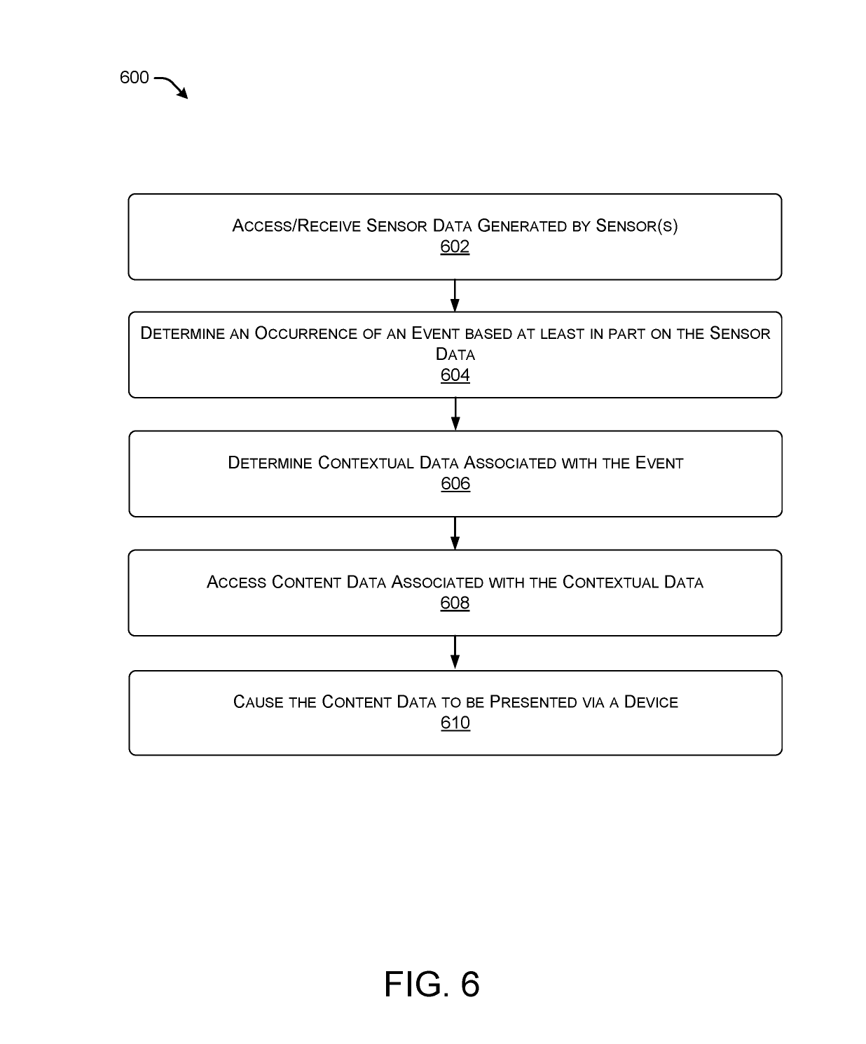

Turning to FIGS. 6-8, the processes described below with reference to FIGS. 6-8 are illustrated as collections of blocks in logical flow graphs, which represent sequences of operations that can be implemented in hardware, software, or a combination thereof In the context of software, the blocks represent computer-executable instructions stored on one or more computer-readable storage media that, when executed by one or more processors, perform the recited operations. Generally, computer-executable instructions include routines, programs, objects, components, data structures, and the like that perform particular functions or implement particular abstract data types. The order in which the operations are described is not intended to be construed as a limitation, and any number of the described blocks can be combined in any order and/or in parallel to implement the processes.

FIG. 6 illustrates an example process 600 to cause contextual content to be presented based on an event (i.e., user confusion).

Block 602 illustrates accessing/receiving sensor data generated by sensor(s) 108. As described above, in at least one example, the sensor data collection module(s) 118 can receive sensor data from corresponding sensor(s) 108. The sensor data can include, but is not limited to, measurements associated with galvanic skin response, skin temperature, electrical activity of the brain, electrical activity of the heart, eye movement, facial expressions, pupil dilation and/or contraction, a volume of speech, a rate of speech, etc., as described above.

Block 604 illustrates determining an occurrence of an event based at least in part on the sensor data. As described above, for each sensor of the one or more sensors 108, a corresponding confusion detection module 130 can be configured to determine state data indicating a percentage, a probability, etc. that a user 114 is likely to be confused. As described above, in some examples the confusion detection module 130 can send state data to the confusion determination module 119. In at least one example, the confusion determination module 119 can include one or more machine learning technologies for determining the confused mental state of the user 114. The confusion determination module 119 can determine whether the user 114 is confused based at least in part on the state data.

In at least one example, as described above, based at least in part on determining that a user 114 is confused, the confusion determination module 119 can determine an occurrence of an event and can send event data to the operating system 116. In at least one example, the event data can indicate that the confusion determination module 119 has detected that the user 114 is confused. In at least one example, the operating system 116 can send notification data to the context determination module 120. As described above, the notification data can include instructions to initiate accessing content data and causing the content data to be presented via the device 102.

In an alternative example, a confusion detection module 130 can be configured to determine that a user 114 is confused based at least in part on the sensor data received from a corresponding sensor. In at least one example, the confusion detection module 130 can include one or more machine learning technologies for determining the confused mental state of the user 114. In the alternative example, based at least in part on determining that a user 114 is confused, the confusion detection module 130 can determine an occurrence of an event and can send event data to the operating system 116. That is, in some examples, the confusion detection module 130 can communicate directly with the operating system 116. In at least one example, the event data can indicate that the confusion detection module 130 has detected that the user 114 is confused. In at least one example, the operating system 116 can send notification data to the context determination module 120. As described above, the notification data can include instructions to initiate accessing content data and causing the content data to be presented via the device 102.

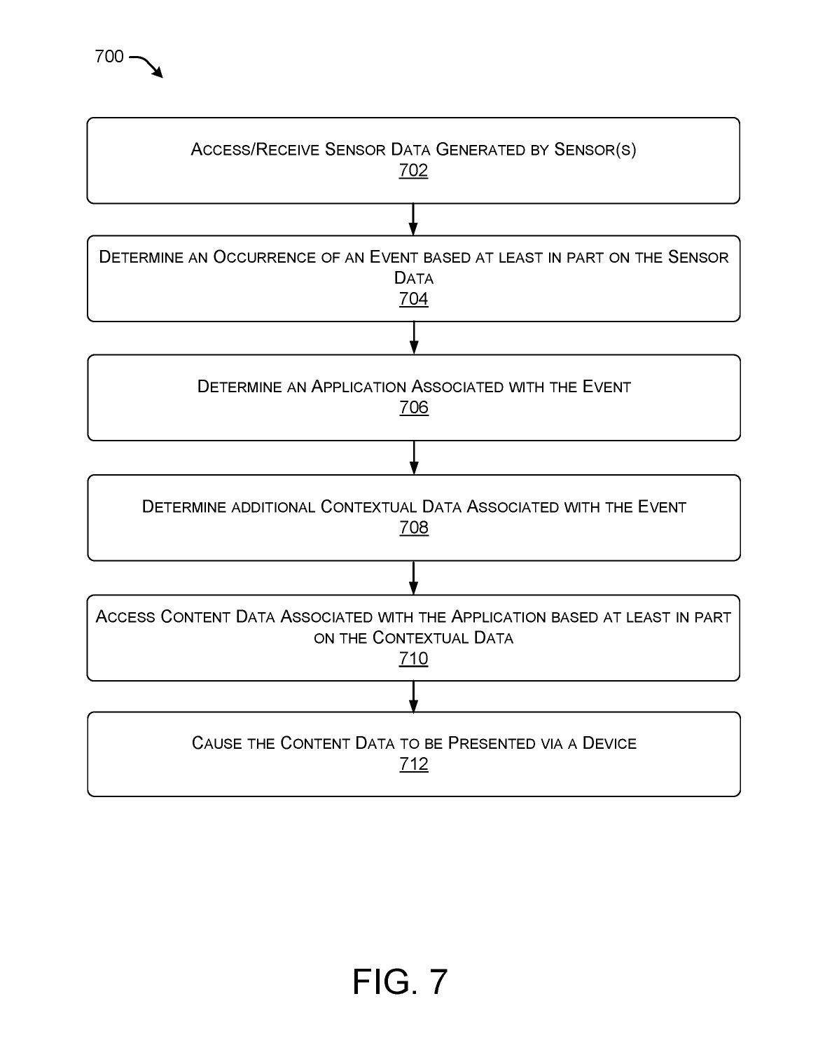

Block 606 illustrates determining contextual data associated with the event. As described above, the context determination module 120 can determine contextual data associated with the event. The contextual data can indicate an application, a feature, a function, etc. that the user 114 was interacting with, or one or more actions taken by the user 114, at substantially the same time, or immediately preceding, the determination of the confused mental state. Additional details associated with determining contextual data are described with reference to FIGS. 4 and 7.

Block 608 illustrates accessing content data associated with the contextual data. As described above, in some examples, the context determination module 120 can send command data and contextual data to the application that the user 114 was interacting with when the confusion detection module 130 determined a confused mental state. Responsive to receiving the command data and the contextual data, the application can access or generate content data. In some examples, the content data can be previously defined content that corresponds to the contextual data determined by the context determination module 142. In other examples, the content data can be generated based on a series of events, as described above. In at least one example, as described above, the context determination module 120 can send command data to the content presentation module 122 and the content presentation module 122 can access the content data from the application.

Block 610 illustrates causing the content data to be presented via a device 102. In at least one example, an application can determine a presentation of the content data via the device 102 and can send the content data and presentation data to the output interface(s) 112. In such examples, the application can determine how the content data 428 should be presented via the device 102, as described above. In alternative examples, the content presentation module 122 can determine a how the content data should be presented via the device 102 and the content presentation module 122 can send the content data and presentation data to the output interface(s) 112.

As described above, the content presentation module 122 and/or the application(s) 124 can present content via an output interface 112 of the device 102. In at least one example, the content presentation module 122 and/or the application(s) 124 can cause content to be presented via a graphical representation 134 of content that can be output via a display of the device 102. As described above, in at least one example, the display can be a hardware display surface 128 that can be configured to provide a real-world view of an object through the hardware display surface while also presenting the graphical representation 134. In an alternative and/or additional example, the content presentation module 122 can cause the content to be presented as spoken language output via a speaker associated with the device 102. In yet other examples, the content presentation module 122 can cause the content to be presented via haptic response output by the device 102. Additional details associated with presenting content are described below with reference to FIGS. 5A-5D, 9A-9C, and 11A-11F.

FIG. 7 illustrates another example process 700 to cause contextual content to be presented based on an event (i.e., user confusion).

Block 702 illustrates accessing/receiving sensor data generated by sensor(s) 108. As described above, in at least one example, the sensor data collection module(s) 118 can receive sensor data from corresponding sensor(s) 108. The sensor data can include, but is not limited to, measurements associated with galvanic skin response, skin temperature, electrical activity of the brain, electrical activity of the heart, eye movement, facial expressions, pupil dilation and/or contraction, a volume of speech, a rate of speech, etc., as described above.

Block 704 illustrates determining an occurrence of an event based at least in part on the sensor data. As described above, for each sensor of the one or more sensors 108, a corresponding confusion detection module 130 can be configured to determine state data indicating a percentage, a probability, etc. that a user 114 is likely to be confused. As described above, in some examples the confusion detection module 130 can send state data to the confusion determination module 119. In at least one example, the confusion determination module 119 can include one or more machine learning technologies for determining the confused mental state of the user 114. The confusion determination module 119 can determine whether the user 114 is confused based at least in part on the state data.

In at least one example, as described above, based at least in part on determining that a user 114 is confused, the confusion determination module 119 can determine an occurrence of an event and can send event data to the operating system 116. In at least one example, the event data can indicate that the confusion determination module 119has detected that the user 114 is confused. In at least one example, the operating system 116 can send notification data to the context determination module 120. As described above, the notification data can include instructions to initiate accessing content data and causing the content data to be presented via the device 102.

As described above, in an alternative example, a confusion detection module 130 can be configured to determine that a user 114 is confused based at least in part on the sensor data received from a corresponding sensor and, based at least in part on determining that a user 114 is confused, the confusion detection module 130 can determine an occurrence of an event and can send event data to the operating system 116. That is, in some examples, the confusion detection module 130 can communicate directly with the operating system 116. As described above, the operating system 116 can send notification data to the context determination module 120.

Block 706 illustrates determining an application associated with the event. As described above, in at least one example, the context determination module 120 can access the datastore 126 to access the logs associated with activities performed by the device 102. The context determination module 120 can analyze the logs to determine which application of the application(s) 124 the user 114 was interacting with at substantially the same time that the event data was generated. For instance, the context determination module 120 can determine which application of the application(s) 124 was in focus at or near the time that the user confusion was detected.

Block 708 illustrates determining additional contextual data associated with the event. In at least one example, the context determination module 120 can leverage sensor data received from the sensor(s) 108 and/or input data received from the input interface(s) 110 to determine a feature and/or a function of the application that the user 114 was interacting with at or near the time the event data was generated, as described above. In additional and/or alternative examples, the context determination module 120 can determine one or more actions that occurred immediately prior to the generation of the event data. In at least one example, the context determination module 120 can access the datastore 126 to access the logs associated with activities performed by the device 102, as described above. The context determination module 120 can analyze the logs to determine one or more actions performed immediately preceding the time that the event data was generated. Additionally and/or alternatively, the context determination module 120 can leverage sensor data received from the sensor(s) 108 and/or input data received from the input interface(s) 110 to determine a feature and/or a function of the application that the user 114 was interacting with at or near the time the event data was generated. In at least one example, the one or more actions can be associated with various application(s) 124, as described above.

Block 710 illustrates accessing content data associated with the application based at least in part on the contextual data. As described above, in some examples, the context determination module 120 can send command data and contextual data to the application that the user 114 was interacting with when the confusion detection module 130 determined a confused mental state. Responsive to receiving the command data and the contextual data, the application can access or generate content data. In some examples, the content data can be previously defined content that corresponds to the contextual data determined by the context determination module 142. In other examples, the content data can be generated based on a series of events, as described above. In such examples, the application can present a programmer with a series of events to trigger arbitrary call execution and enable the programmer to write custom handlers based on the series of events. In at least one example, as described above, the context determination module 120 can send command data to the content presentation module 122 and the content presentation module 122 can access the content data from the application.

Block 712 illustrates causing the content data to be presented via a device 102. In at least one example, an application can determine a presentation of the content data via the device 102 and can send the content data and presentation data to the output interface(s) 112. In such examples, the application can determine how the content data 428 should be presented via the device 102, as described above. In alternative examples, the content presentation module 122 can determine a how the content data should be presented via the device 102 and the content presentation module 122 can send the content data and presentation data to the output interface(s) 112.

As described above, the content presentation module 122 and/or the application(s) 124 can present content via an output interface 112 of the device 102. In at least one example, the content presentation module 122 and/or the application(s) 124 can cause content to be presented via a graphical representation 134 of content that can be output via a display of the device 102. As described above, in at least one example, the display can be a hardware display surface 128 that can be configured to provide a real-world view of an object through the hardware display surface while also presenting the graphical representation 134. In an alternative and/or additional example, the content presentation module 122 can cause the content to be presented as spoken language output via a speaker associated with the device 102. In yet other examples, the content presentation module 122 can cause the content to be presented via haptic response output by the device 102. Additional details associated with presenting content are described below with reference to FIGS. 5A-5D, 9A-9C, and 11A-11F.

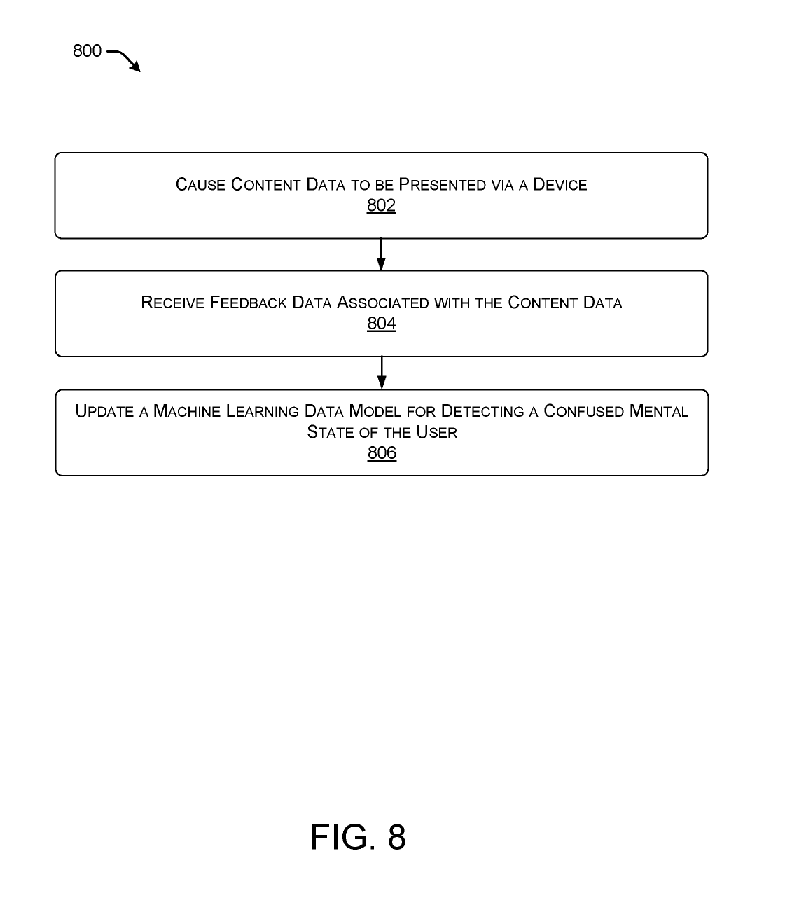

FIG. 8 illustrates an example process 800 to update machine learning technologies for detecting a confused mental state of a user.

Block 802 illustrates causing content data to be presented via a device 102. As described above, the content presentation module 122 and/or the application(s) 124 can present content via an output interface 112 of the device 102. In at least one example, the content presentation module 122 and/or the application(s) 124 can cause content to be presented via a graphical representation 134 of content that can be output via a display of the device 102. As described above, in at least one example, the display can be a hardware display surface 128 that can be configured to provide a real-world view of an object through the hardware display surface while also presenting the graphical representation 134. In an alternative and/or additional example, the content presentation module 122 can cause the content to be presented as spoken language output via a speaker associated with the device 102. In yet other examples, the content presentation module 122 can cause the content to be presented via haptic response output by the device 102. Additional details associated with presenting content are described below with reference to FIGS. 5A-5D, 9A-9C, and 11A-11F.

As described above, in at least one example, a feedback mechanism can be associated with the content data. For instance, a graphical representation of the content data can include a sliding scale, a multiple choice question, a Likert question, a drop down menu, hyperlinks, overlays, or other mechanisms for providing functionality for the user to indicate whether content presented to the user was helpful, whether the user was confused, etc. Alternatively, a spoken representation of the content data can include spoken output that prompts a user for feedback. For instance, the spoken output might ask “Did this tip help alleviate your confusion?” A haptic representation of the content data can be associated with a particular tactile interaction that is indicative of feedback. For instance, a user 114 can shake the device 102 a predetermined number of times or in a particular direction to provide feedback associated with the content data. Interactions with the feedback mechanisms can generate feedback data.

Block 804 illustrates receiving feedback data associated with the content data. The feedback module 132 can receive feedback data generated based on user interactions with the feedback mechanisms, as described above.

Block 806 illustrates updating a machine learning data model for detecting a confused mental state of the user 114 based at least in part on the feedback data. In at least one example, the feedback module 132 can provide the feedback data to the confusion detection module 130. In such an example, the confusion detection module 130 can leverage the feedback data to refine the data model and improve the accuracy and/or precision with which the data model identifies when a user 114 is confused. In additional and/or alternative examples, the feedback module 132 can provide the feedback data to the confusion determination module 119, and the confusion determination module 119 can leverage the feedback data to refine the data model by updating weights associated with individual signals. Based at least in part on refining the data model, the accuracy and/or precision with which the data model identifies when a user 114 is confused can be improved.

Referring now to FIGS. 9A-9C, 10A-10F, and 11A-11F, the following section describes techniques for identifying a gaze target. FIG. 9A is back view of a device 900 (e.g., device 102, device 102, etc.) having a hardware display surface 902 (e.g., hardware display surface 128) and one or more sensors 904 (e.g., sensor(s) 108). To facilitate functionality described herein, in at least one example, sensor(s) 904′ can be configured to track the position of at least one eye of a user 114. In addition, at least one other sensor 904 can be directed toward a real-world object for generating image data of the real-world object. As will be described in more detail below, examples can process eye position data, image data, and other data to identify a gaze target that is a rendered object displayed on a hardware display surface 902 or a real-world object viewed through a transparent section of the hardware display surface 902. As will also be described below, examples described herein can also determine if the user 114 is looking at a particular section of a hardware display surface 902, a particular part of a real-world object, or a particular part of a rendered object. Such information can be useful for determining the appropriate content to present based on detected user confusion, as described above.

In FIG. 9A, the device 900 comprises two sensors 904′ for generating data or a signal indicating the position or movement of at least one eye of a user 114. The sensors 904′ can be in the form of a camera or another suitable device for tracking the position or movement of at least one eye of a user 114. The device 102 also comprises at least one hardware display surface 902 for allowing a user 114 to view one or more objects. The hardware display surface 902 can provide a view of a real-world object through the hardware display surface 902 as well as images of rendered objects that can be displayed on the hardware display surface 902, as described above.

FIG. 9B is a side cutaway view 906 of the device 900 shown in FIG. 9A. FIG. 9B includes an eye 908 of a user 114 looking through the hardware display surface 902. The hardware display surface 902 is configured to create transparent sections enabling a user 114 to view objects through the hardware display surface 902. FIG. 9B shows an example arrangement where a real-world object 910 is aligned with a transparent section of the hardware display surface 902 allowing the user 114 to view the real-world object 910 through the hardware display surface 902. The hardware display surface 902 can display one or more rendered objects. The device 102 also comprises at least one sensor 904′ directed toward at least one eye 908 of the user 114.

FIG. 9C illustrates an example view 912 that can be observed by a user 114 via the hardware display surface 902. The thick double line 914 illustrates the boundary of the hardware display surface 902. In this illustrative example, the view 912 includes a first rendered object 916, a second rendered object 918, and a third rendered object 920 that are displayed on the hardware display surface 902. The real-world object 910 is viewed through the hardware display surface 902.

In a non-limiting example described above, a user 114 can be interacting with a gaming application of the application(s) 124. For instance, the gaming application can include the first rendered object 916 and the second rendered object 918, which can each represent a ball, and the premise of the gaming application can be to put the balls in a basket, represented by the real-world object 910. The confusion detection module 130 can receive sensor data indicating that the user 114 is confused. The context determination module 120 can receive gaze data indicating that the real-world object 910 is the gaze target when the context determination module 120 detects user confusion. Accordingly, the context determination module 120 can determine that the user 114 is confused about how to interact with the real-world object 910 in the context of the gaming application. The gaming application and/or the content presentation module 122 can cause a graphical representation of the content data to be presented via the hardware display surface 902. The third rendered object 920 can correspond to the graphical representation of content data configured to mitigate any confusion associated with the gaming application. In the non-limiting example, the third rendered object 920 can be a tip instructing the user 114 to drop the balls in the basket to earn points.

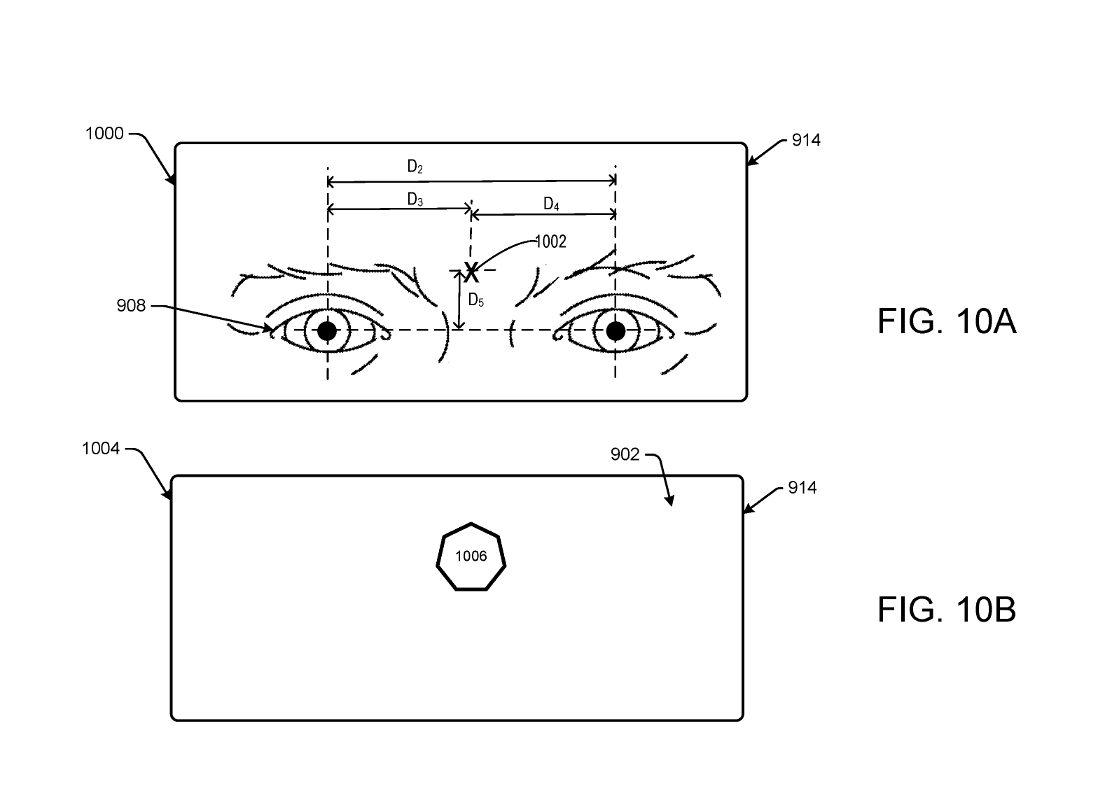

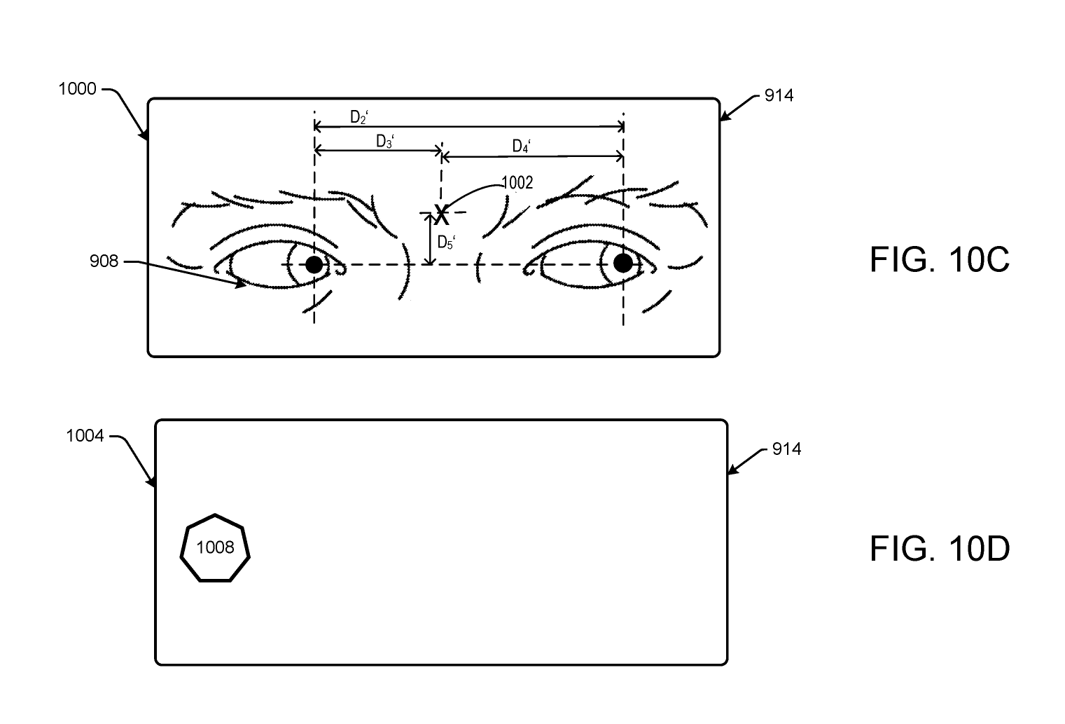

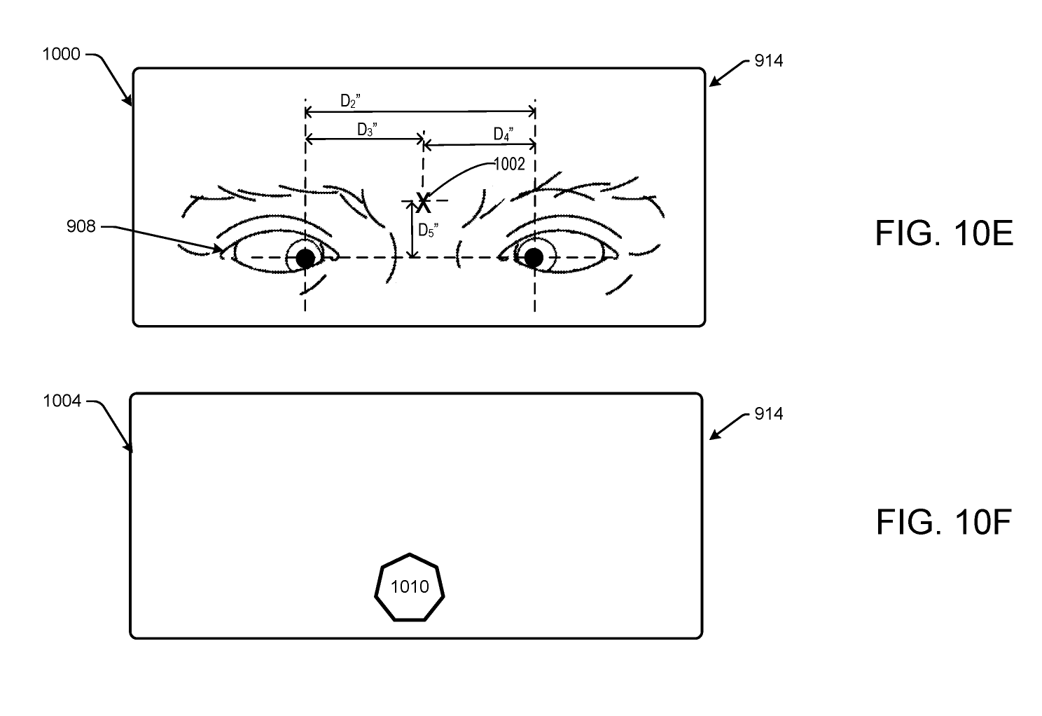

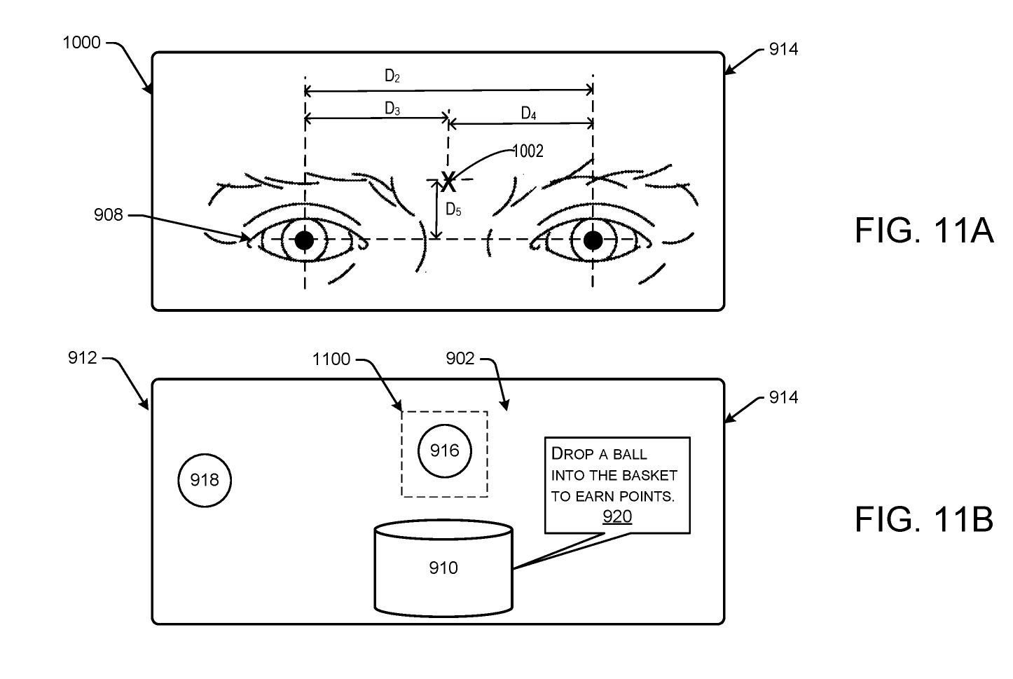

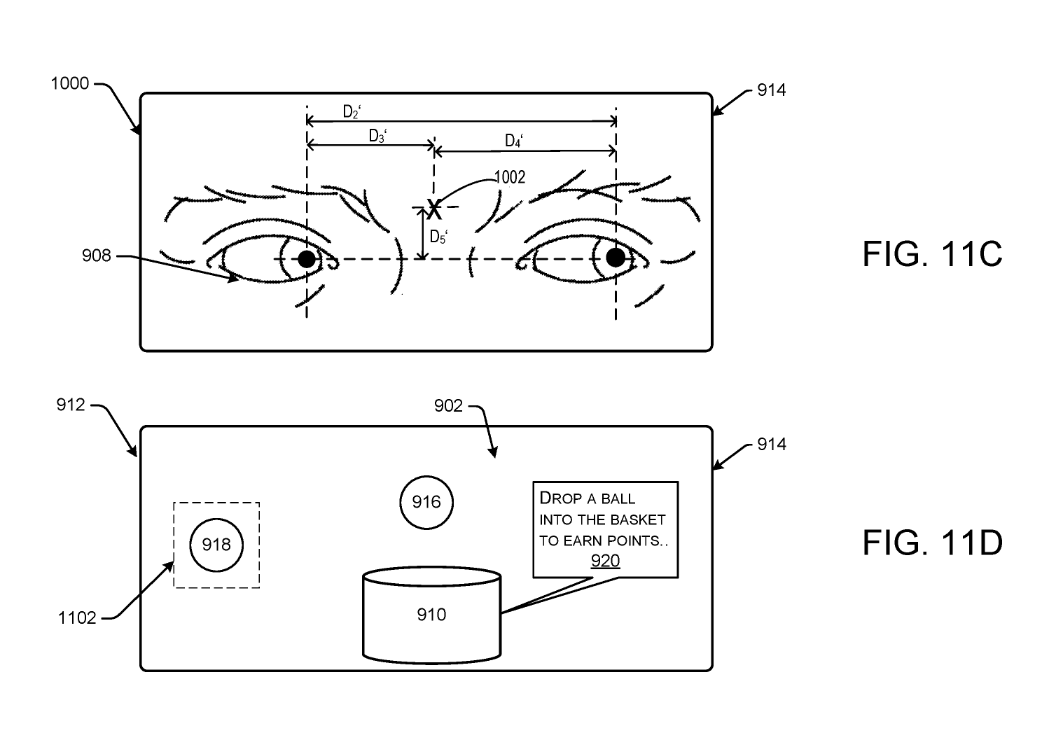

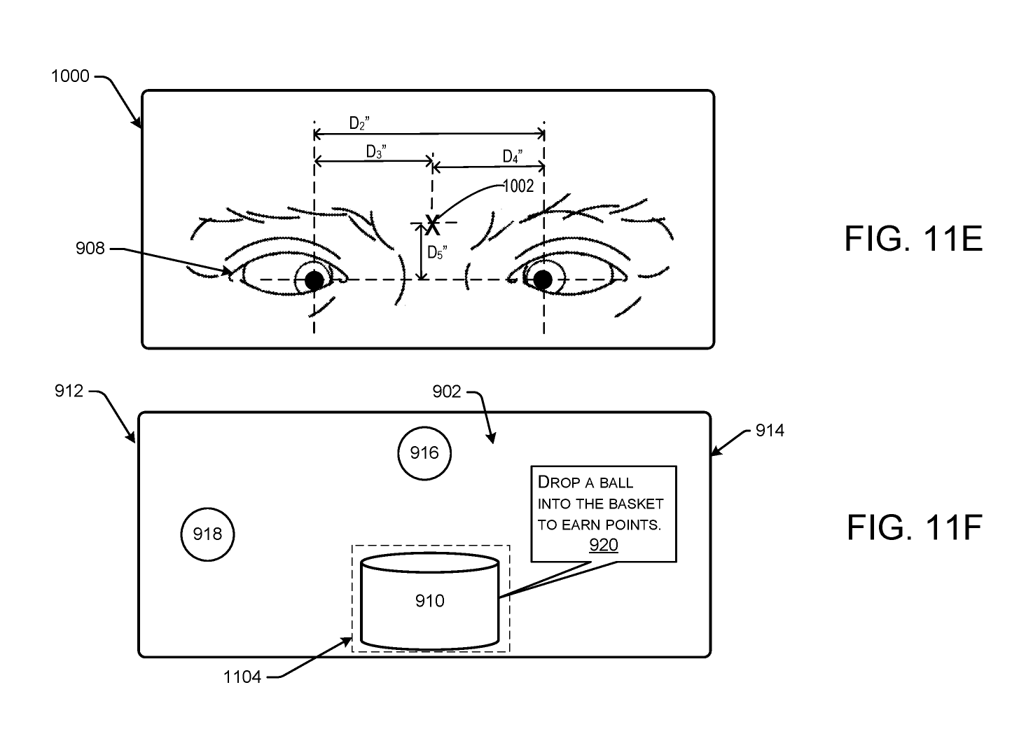

To facilitate aspects of such an example, the device 102 can utilize one or more techniques for calibrating the device 102. The following section, in conjunction with FIGS. 10A-10F, describes aspects of a technique for obtaining calibration data. A subsequent section, in conjunction with FIG. 11A-FIG. 11F, describes aspects of an example scenario where a device 102 processes the calibration data and other data to identify a gaze target.

A device 900 can be calibrated in a number of ways. In one example, a device 900 can utilize the display of a number of graphical elements at predetermined locations. As the graphical elements are displayed, the device 900 can prompt the user to look at a particular graphical element and provide an input to verify that the user 114 is looking at the particular graphical element. When the user verifies that he or she is looking at the particular graphical element, sensor(s) 904′ can generate eye position data defining a position of at least one eye. The eye position data can be stored in a data structure in memory in response to receiving the verification from the user 114.

FIG. 10A illustrates an example view 1000 that can be captured by the sensors 904′ of the device 900. From such a perspective, the device 900 can determine one or more values that define the position of at least one eye 908 of the user 114. In one illustrative example, the values can include a second value (D2) indicating a distance between a user's eyes and a third value (D3), fourth value (D4), and a fifth value (D5) indicating a distance between at least one eye of the user 114 and a reference point 1002. It can be appreciated that by the use of one or more image processing technologies, one or more aspects of an eye, such as the pupil, can be identified and utilized to determine an eye position.

In addition, by the use of one or more suitable technologies, a reference point 1002 can be selected. A reference point 1002 can be based on a feature of the user, e.g., a tip of a nose, an eyebrow, a beauty mark, or a reference point 1002 can be in an arbitrary location. In the example of FIG. 10A, a point between the user's eyes is used as a reference point 1002. This example reference point 1002 is provided for illustrative purposes and is not to be construed as limiting. It can be appreciated that the reference point 1002 is can be in any suitable location, which can be based on an identifiable feature or characteristic of a user or any object.

As described above, a device 900 can generate a number of graphical elements at predetermined locations of the hardware display surface 902. As the graphical elements are displayed on the hardware display surface 902, the device 900 can prompt the user 114 to look at the graphical elements and provide an input to verify that the user is looking at the graphical elements. FIG. 10B illustrates an example view 1004 of a graphical element 1006 that can be generated by the device 900 to facilitate the calibration process. In this example, the device 900 generates a rendering of a graphical element 1006 in the center of the viewing area. While the graphical element 1006 is displayed, the device 900 can generate a prompt for the user 114 to verify that he or she is looking at the graphical element 1006. The prompt, as well as a user response to the prompt, can include a gesture, voice command, or other suitable types of input.

When the device 900 verifies that the user 114 is looking at the graphical element 1006, the device 900 can record one or more values indicating the position and/or the movement of at least one eye 908 of the user 114. For instance, one or more values described above and shown in FIG. 9B and FIG. 10A can be stored in a data structure in memory. It can be appreciated that any suitable value or a combination of values can be stored and utilized, including but not limited to, the first value (D₁) indicating the distance between the sensors 904 and at least one eye 904 of a user 114, the second value (D₂) indicating the distance between the eyes of a user 114, and other values (D₃, D₄, and D₅) indicating the distance between at least one eye 904 and a reference point 1002. These values are provided for illustrative purposes and are not to be construed as limiting. It can be appreciated that such values, subsets of such values, and other values of other measurements can be utilized in determining the movement and/or the position of one or more eyes of a user.

Other sets of values can be measured during the display of other graphical elements displayed in various positions. For example, as shown in FIG. 10C, a second set of values (D₂′, D₃′, D₄′, and D₅′) can be measured when a second graphical element 1008 is displayed, as shown in FIG. 10D. As shown in FIG. 10E, a third set of values (D₂″, D₃″, D₄″, and D₅″) can be measured when a third graphical element 1010 is displayed, as shown in FIG. 10F.

These example measurements and the locations of the graphical elements are provided for illustrative purposes. It can be appreciated that any number of graphical elements can be placed at different locations to obtain measurements that can be used to calibrate a device 900. For example, the device 900 can sequentially display a graphical element at pre-determined locations of the view 1004, such as each corner of the view 1004. As can be appreciated, more or fewer graphical elements can be used in the calibration process.

The values that indicate the position of at least one eye 908 at each pre-determined location can be used to generate calibration data. The calibration data can be configured to correlate the sets of eye position data with data identifying the positions of the graphical elements.

Any known technique suitable for generating calibration data can be used. It can be appreciated that the generation of calibration data can include extrapolation, projection and/or estimation technologies that can project correlations between sets of eye position data and various sections of a hardware display surface 902 and/or pixels of a hardware display surface 902. These examples are provided for illustrative purposes and are not to be construed as limiting, it can be appreciated that the values and/or calibration data can be obtained in other ways, including receiving such calibration data from one or more remote resources.

Once the calibration data is generated or obtained, such data and other data can be utilized by the device 102 to determine if a user 114 is looking at a particular gaze target, which can include a part of a hardware display surface 902, a rendered object, part of a rendered object, a real-world object, or part of a real-world object. FIGS. 11A-11F describes aspects of an example scenario where the device 900 having at least one sensor 904′ is used to track the movement of at least one eye 908 of a user 114 to identify a gaze target.

Referring now to FIG. 11A and FIG. 11B, an example scenario showing the identification of a gaze target is shown and described. In this example, the user 114 is looking at the example view 912. As summarized above with reference to FIG. 9C, the example view 912 comprises both a view of a rendered objects (e.g., first rendered object 916, second rendered object 918, and third rendered object 920) on the hardware display surface 902 as well as a view of a real-world object 910 through the hardware display surface 902. While the user 114 is looking at the view 912, the sensor(s) 904′ can cause the generation of one or more measured values, such as the values shown in the FIG. 11A. In some examples, using any combination of suitable technologies, such values can be compared against the calibration data and/or other data to identify a gaze target. In this example, one or more values measured in the scenario depicted in FIG. 11A can be processed with the calibration data to determine that the user 114 is looking at the first rendered object 916. In such an example, the one or more measured values shown in FIG. 11A can also be used to determine that the user 114 is looking at a predetermined section of an interface, such as the first section 1100 of the hardware display surface 902 in FIG. 11B.

In continuing the present example, one or more values measured in the scenario depicted in FIG. 11C can be processed with the calibration data to determine that the user 114 is looking at the second rendered object 918. In such an example, the one or more measured values shown in FIG. 11C can also be used to determine that the user 114 is looking at a second section 1102 of the hardware display surface 902 in FIG. 11D.

In continuing the present example, one or more values measured in the scenario depicted in FIG. 11E can be processed with the calibration data to determine that the user 114 is looking at the real-world object 910. In such an example, the one or more measured values shown in FIG. 11E can be processed with the calibration data to determine that the user 114 is looking at a third section 1104 of the hardware display surface 902 in FIG. 11F.

In some examples, the device 900 can utilize data from a combination of resources to determine if a user 114 is looking at the real-world object 910 through the hardware display surface 902. As summarized above, a camera or other type of sensor 904 (FIG. 9A) mounted to the device 102 can be directed towards a user's field of view. Image data generated from the camera can be analyzed to determine if an object in the field of view is in a pre-determined position of an image of the image data. If an object is positioned within a pre-determined area of an image, such as the center of the image, a device can determine a gaze target processing such data with eye position data. Such data can be utilized to supplement other types of data, such as position data from a GPS and/or data generated from a compass or accelerometer, to enable a device 102 to determine a gaze direction, e.g., left, right, up, or down, and/or a gaze target.

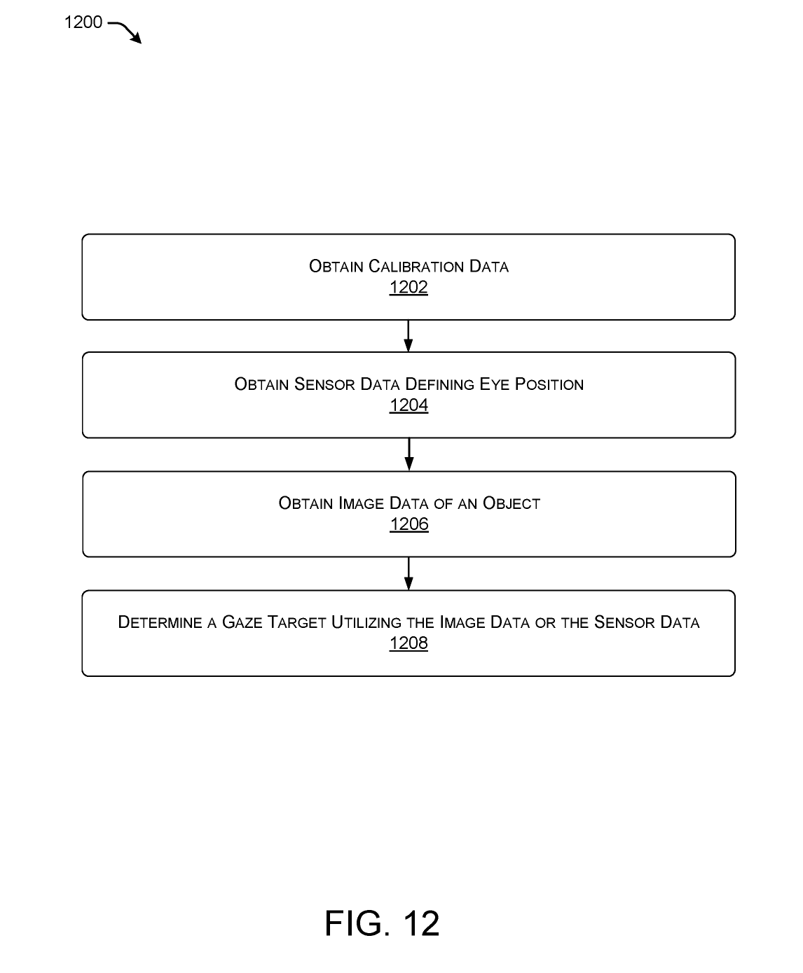

Turning now to FIG. 12, aspects of an example process 1200 for determining a gaze target is shown and described below. In FIG. 12, device 900 can correspond to device 102, as described above.

Block 1202 illustrates obtaining calibration data. In at least one example, the operating system 116, or another module associated with the computer-readable media 106, can obtain calibration data. The calibration data can be stored in a data structure in the computer-readable media 106 or any computer readable storage medium for access at a later time. The calibration data can be generated by the device 900 or the calibration data can be received from a remote resource. In some examples, sensors 904′ of a device 900 can be positioned to track the position of at least one eye of a user 114. The sensors 904′ can cause the generation of one or more values that correlate the position of at least one eye of a user 114 with a particular section or position of a hardware display surface 902. Such examples can utilize an initialization process where the device 900 displays one or more graphical elements at pre-determined locations. During the display of the one or more graphical elements, one or more inputs from a user 114 can indicate that they are looking at the one or more graphical elements. In response to the input, a device can generate calibration data comprising the values that correlate the position of at least one eye of a user 114 with data identifying a particular position or section of a hardware display surface 902.

Block 1204 illustrates obtaining sensor data indicating the position of at least one eye of the user. In at least one example, the operating system 116, or another module associated with the computer-readable media 106, can obtain sensor data. The sensor data can be stored in a data structure in the computer-readable media 106 or any computer readable storage medium for access at a later time. As summarized above, sensor(s) 904′ directed toward at least one eye of the user 114 can cause the generation of sensor data indicating the position of at least one eye of the user 114. The sensor data can be processed to generate data indicating a gaze direction of a user 114. As will be described below, the data indicating the gaze direction of the user 114 can be processed with the calibration data to determine if the user 114 is looking at a gaze target, which can include a rendered obj ect displayed on the hardware display surface 902.

Block 1206 illustrates obtaining image data of an object. In at least one example, the operating system 116, or another module associated with the computer-readable media 106, can obtain sensor data. The image data of the obj ect can be stored in a data structure in the computer-readable media 106 or any computer readable storage medium for access at a later time. In some examples, a camera or other type of sensor 904 mounted to a device 900 can be directed towards a user's field of view. The camera or other type of sensor 904 can cause the generation of image data, which can include one or more images of an object that is in the user's field of view. The image data can be in any suitable format and generated by any suitable sensor 904, which can include the use of a depth map sensor, camera, etc.

Block 1208 illustrates determining a gaze target utilizing the image data or the sensor data. In at least one example, the context determination module 120, or another module associated with the computer-readable media 106, can determine the gaze target. For instance, if a user 114 is looking at a real-world view of the object through the hardware display surface 902, and a sensor 904 directed towards the user's field of view generates image data of the object, the image data can be analyzed to determine if the object in the field of view is in a pre-determined position of an image of the image data. For example, if an object is positioned within a pre-determined area of an image, such as the center of the image, a device 900 can determine that the object is a gaze target. In another example, sensor data indicating the position of at least one eye of the user 114 can be processed with the calibration data and/or image data to determine if the user 114 is looking at a rendered object displayed on the hardware display surface 902. Such an example can be used to determine that the rendered object displayed on the hardware display surface 902 is a gaze target.

FIG. 13 shows additional details of an example computer architecture 1300 for a computer, such as device 102, device 102, and/or server(s) 304 (FIGS. 1, 2, and 3, respectively), capable of executing the program components described above for causing contextual content to be presented based on determining user confusion. Thus, the computer architecture 1300 illustrated in FIG. 13 illustrates an architecture for a server computer, mobile phone, a PDA, a smart phone, a desktop computer, a netbook computer, a tablet computer, a laptop computer, and/or a wearable computer. The computer architecture 1300 can be utilized to execute any aspects of the software components presented herein.

The computer architecture 1300 illustrated in FIG. 13 includes a central processing unit 1302 (“CPU”), a system memory 1304, including a random access memory 1306 (“RAM”) and a read-only memory (“ROM”) 1308, and a system bus 1310 that couples the memory 1304 to the CPU 1302. A basic input/output system containing the basic routines that help to transfer information between elements within the computer architecture 1300, such as during startup, is stored in the ROM 1308. The computer architecture 1300 further includes a mass storage device 1312 for storing an operating system 1314 (e.g., operating system 116, server operating system 312, etc.), application(s) 1316 (e.g., application(s) 124) programs, module(s) 1318 (e.g., the sensor data collection module(s) 118, the context determination module 120, the content presentation module 122, the context determination module 316, the content presentation module 318, etc.), etc., as described above with reference to FIGS. 1-3. Additionally and/or alternatively, the mass storage device 1312 can store sensor data 1320 (e.g., sensor data 402), state data 1321 (e.g., state data 406) image data 1322, calibration data 1324, contextual data 1326 (e.g., contextual data 424), content data 1328 (e.g., content data 434), presentation data 1330 (e.g., presentation data 436), etc., as described herein.

The mass storage device 1312 is connected to the CPU 1302 through a mass storage controller (not shown) connected to the bus 1310. The mass storage device 1312 and its associated computer-readable media provide non-volatile storage for the computer architecture 1300. Computer-readable media 106, computer-readable media 208, and computer-readable media 310 can correspond to mass storage device 1312. Although the description of computer-readable media contained herein refers to a mass storage device, such as a solid state drive, a hard disk or CD-ROM drive, it should be appreciated by those skilled in the art that computer-readable media can be any available computer storage media or communication media that can be accessed by the computer architecture 1300.

Communication media includes computer readable instructions, data structures, program modules, or other data in a modulated data signal such as a carrier wave or other transport mechanism and includes any delivery media. The term “modulated data signal” means a signal that has one or more of its characteristics changed or set in a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of communication media.

By way of example, and not limitation, computer storage media can include volatile and non-volatile, removable and non-removable media implemented in any method or technology for storage of information such as computer-readable instructions, data structures, program modules or other data. For example, computer storage media includes, but is not limited to, RAM, ROM, erasable programmable read-only memory (“EPROM”), electrically erasable programmable read-only memory (“EEPROM”), flash memory or other solid state memory technology, compact disc read-only memory (“CD-ROM”), digital versatile disks (“DVD”), high definition/density digital versatile/video disc (“HD-DVD”), BLU-RAY disc, or other optical storage, magnetic cassettes, magnetic tape, magnetic disk storage or other magnetic storage devices, or any other medium which can be used to store the desired information and which can be accessed by the computer architecture 1300. For purposes of the claims, the phrase “computer storage medium,” “computer-readable storage medium,” and variations thereof, does not include waves, signals, and/or other transitory and/or intangible communication media, per se.

According to various configurations, the computer architecture 1300 can operate in a networked environment using logical connections to remote computers through the network 1332 and/or another network (not shown). The computer architecture 1300 can connect to the network 1332 through a network interface unit 1334 connected to the bus 1310. It should be appreciated that the network interface unit 1334 also can be utilized to connect to other types of networks and remote computer systems. The computer architecture 1300 also can include an input/output controller 1336 for receiving and processing input from input device(s) or input interface(s) (e.g., input interface(s) 110), including a keyboard, mouse, or electronic stylus (not shown in FIG. 13). Similarly, the input/output controller 1336 can provide output to a display screen, a printer, other type of output device, or output interface (also not shown in FIG. 13). The input/output controller 1336 can receive and process data from the input interface(s) 110 and/or output interface(s) 112 described above with reference to FIG. 1.

It should be appreciated that the software components described herein can, when loaded into the CPU 1302 and executed, transform the CPU 1302 and the overall computer architecture 1300 from a general-purpose computing system into a special-purpose computing system customized to facilitate the functionality presented herein. The CPU 1302 can be constructed from any number of transistors or other discrete circuit elements, which can individually or collectively assume any number of states. More specifically, the CPU 1302 can operate as a finite-state machine, in response to executable instructions contained within the software modules described herein. These computer-executable instructions can transform the CPU 1302 by specifying how the CPU 1302 transitions between states, thereby transforming the transistors or other discrete hardware elements constituting the CPU 1302. Processor(s) 104, processor(s) 206, and processor(s) 308 can correspond to CPU 1302.

Encoding the software modules presented herein also can transform the physical structure of the computer-readable media presented herein. The specific transformation of physical structure can depend on various factors, in different implementations of this description. Examples of such factors can include, but are not limited to, the technology used to implement the computer-readable media, whether the computer-readable media is characterized as primary or secondary storage, and the like. For example, if the computer-readable media is implemented as semiconductor-based memory, the software described herein can be encoded on the computer-readable media by transforming the physical state of the semiconductor memory. For example, the software can transform the state of transistors, capacitors, or other discrete circuit elements constituting the semiconductor memory. The software also can transform the physical state of such components in order to store data thereupon.

As another example, the computer-readable media described herein can be implemented using magnetic or optical technology. In such implementations, the software presented herein can transform the physical state of magnetic or optical media, when the software is encoded therein. These transformations can include altering the magnetic characteristics of particular locations within given magnetic media. These transformations also can include altering the physical features or characteristics of particular locations within given optical media, to change the optical characteristics of those locations. Other transformations of physical media are possible without departing from the scope and spirit of the present description, with the foregoing examples provided only to facilitate this discussion.

In light of the above, it should be appreciated that many types of physical transformations take place in the computer architecture 1300 in order to store and execute the software components presented herein. It also should be appreciated that the computer architecture 1300 can include other types of computing entities, including hand-held computers, embedded computer systems, personal digital assistants, and other types of computing entities known to those skilled in the art. It is also contemplated that the computer architecture 1300 may not include all of the components shown in FIG. 13, can include other components that are not explicitly shown in FIG. 13, or can utilize an architecture completely different than that shown in FIG. 13.

FIG. 14 depicts an illustrative distributed computing environment 1400 capable of executing the software components described herein for causing contextual content to be presented based at least in part on determined user confusion. Thus, the distributed computing environment 1400 illustrated in FIG. 14 can be utilized to execute any aspects of the software components presented herein. For example, the distributed computing environment 1400 can be utilized to execute aspects of the techniques described herein.

According to various implementations, the distributed computing environment 1400 includes a computing environment 1402 operating on, in communication with, or as part of a network 306. In at least one example, at least some of computing environment 1402 can correspond to the one or more servers 304. The network 1404 can be or can include network 206, network 306, network 1332, etc. described above with reference to FIGS. 2, 3, and 13, respectively. The network 1404 also can include various access networks. One or more client devices 1406A-1406N (hereinafter referred to collectively and/or generically as “clients 1406”) can communicate with the computing environment 1402 via the network 1404 and/or other connections (not illustrated in FIG. 14). Device 102 in FIG. 1, device 102 in FIG. 2, device 900 in FIG. 9 can correspond to any one of the client devices of the client devices 1406A-1406N. In one illustrated configuration, the clients 1406 include a computing device 1406A such as a laptop computer, a desktop computer, or other computing device, a slate or tablet computing device (“tablet computing device”) 1406B, a mobile computing device 1406C such as a mobile telephone, a smart phone, or other mobile computing device, a server computer 1406D, a wearable computer 1406E, and/or other devices 1406N. It should be understood that any number of clients 1406 can communicate with the computing environment 1402. Two example computing architectures for the clients 1406 are illustrated and described herein with reference to FIGS. 13 and 15. It should be understood that the illustrated clients 1406 and computing architectures illustrated and described herein are illustrative, and should not be construed as being limited in any way.

In the illustrated configuration, the computing environment 1402 includes application servers 1408, data storage 1410, and one or more network interfaces 1412. According to various implementations, the functionality of the application servers 1408 can be provided by one or more server computers that are executing as part of, or in communication with, the network 306. The computing environment 1402 can correspond to the one or more servers 304 in FIG. 3. It should be understood that this configuration is illustrative, and should not be construed as being limited in any way. For instance, as described above, in some examples, the application servers 1408 can be associated with the device 142 (e.g., application(s) 124).

In at least one example, the application servers 1408 can host various services, virtual machines, portals, and/or other resources. In the illustrated configuration, the application servers 1408 can host one or more virtual machines 1414 for executing applications or other functionality. According to various implementations, the virtual machines 1414 can execute one or more applications and/or software modules for providing contextual content via devices associated with users 114 based on detecting user confusion. The application servers 1408 also host or provide access to one or more portals, link pages, Web sites, and/or other information (“Web portals”) 1416. The Web portals 1416 can be used to communicate with one or more client computers. The application servers 1408 can include one or more entertainment services 1418. The entertainment services 1418 can include various gaming experiences for one or more users 114.

According to various implementations, the application servers 1408 also include one or more mailbox and/or messaging services 1420. The mailbox and/or messaging services 1420 can include electronic mail (“email”) services, various personal information management (“PIM”) services (e.g., calendar services, contact management services, collaboration services, etc.), instant messaging services, chat services, forum services, and/or other communication services.

The application servers 1408 also can include one or more social networking services 1422. The social networking services 1422 can include various social networking services including, but not limited to, services for sharing or posting status updates, instant messages, links, photos, videos, and/or other information; services for commenting or displaying interest in articles, products, blogs, or other resources; and/or other services. In some configurations, the social networking services 1422 are provided by or include the FACEBOOK° social networking service, the LINKEDIN° professional networking service, the MYSPACE° social networking service, the FOURSQUARE® geographic networking service, the YAMMER® office colleague networking service, and the like. In other configurations, the social networking services 1422 are provided by other services, sites, and/or providers that may or may not be explicitly known as social networking providers. For example, some web sites allow users to interact with one another via email, chat services, and/or other means during various activities and/or contexts such as reading published articles, commenting on goods or services, publishing, collaboration, gaming, and the like. Other services are possible and are contemplated.

The social networking services 1422 also can include commenting, blogging, and/or micro blogging services. Examples of such services include, but are not limited to, the YELP® commenting service, the KUDZU° review service, the OFFICETALK° enterprise micro blogging service, the TWITTER® messaging service, the GOOGLE BUZZ® service, and/or other services. It should be appreciated that the above lists of services are not exhaustive and that numerous additional and/or alternative social networking services 1422 are not mentioned herein for the sake of brevity. As such, the above configurations are illustrative, and should not be construed as being limited in any way. According to various implementations, the social networking services 1422 can host one or more applications and/or software modules for providing the functionality described herein for providing contextually-aware location sharing services for computing devices. For instance, any one of the application servers 1408 can communicate or facilitate the functionality and features described herein. For instance, a social networking application, mail client, messaging client, a browser running on a phone or any other client 1406 can communicate with a social networking service 1422.

As shown in FIG. 14, the application servers 1408 also can host other services, applications, portals, and/or other resources (“other resources”) 1424. The other resources 1424 can deploy a service-oriented architecture or any other client-server management software. It thus can be appreciated that the computing environment 1402 can provide integration of the concepts and technologies described herein with various mailbox, messaging, social networking, and/or other services or resources.

As mentioned above, the computing environment 1402 can include the data storage 1410. According to various implementations, the functionality of the data storage 1410 is provided by one or more databases operating on, or in communication with, the network 306. The functionality of the data storage 1410 also can be provided by one or more server computers configured to host data for the computing environment 1402. The data storage 1410 can include, host, or provide one or more real or virtual containers 1430A-1430N (hereinafter referred to collectively and/or generically as “containers 1430”). Although not illustrated in FIG. 14, the containers 1430 also can host or store data structures and/or algorithms for execution by a module, such as the context determination module 316, the content presentation module 318, etc. Aspects of the containers 1430 can be associated with a database program, file system and/or any program that stores data with secure access features. Aspects of the containers 1430 can also be implemented using products or services, such as ACTIVE DIRECTORY®, DKM®, ONEDRIVE®, DROPBOX® or GOOGLEDRIVE®.

The computing environment 1402 can communicate with, or be accessed by, the network interfaces 1412. The network interfaces 1412 can include various types of network hardware and software for supporting communications between two or more computing entities including, but not limited to, the clients 1406 and the application servers 1408. It should be appreciated that the network interfaces 1412 also can be utilized to connect to other types of networks and/or computer systems.

It should be understood that the distributed computing environment 1400 described herein can provide any aspects of the software elements described herein with any number of virtual computing resources and/or other distributed computing functionality that can be configured to execute any aspects of the software components described herein. According to various implementations of the concepts and technologies described herein, the distributed computing environment 1400 provides the software functionality described herein as a service to the clients 1406. It should be understood that the clients 1406 can include real or virtual machines including, but not limited to, server computers, web servers, personal computers, mobile computing entities, smart phones, and/or other devices. As such, various configurations of the concepts and technologies described herein enable any device configured to access the distributed computing environment 1400 to utilize the functionality described herein for providing contextual content via devices associated with users based on detecting user confusion, among other aspects. In one specific example, as summarized above, techniques described herein can be implemented, at least in part, by a web browser application that can work in conjunction with the application servers 1408 of FIG. 14.

Turning now to FIG. 15, an illustrative computing device architecture 1500 for a computing device that is capable of executing various software components described herein for providing contextual content via devices associated with users based on detecting user confusion. The computing device architecture 1500 is applicable to computing entities that facilitate mobile computing due, in part, to form factor, wireless connectivity, and/or battery-powered operation. In some configurations, the computing entities include, but are not limited to, mobile telephones, tablet devices, slate devices, wearable devices, portable video game devices, and the like. The computing device architecture 1500 is applicable to any of the clients 1006 shown in FIG. 14 (e.g., device 102, device 102, device 900). Moreover, aspects of the computing device architecture 1500 can be applicable to traditional desktop computers, portable computers (e.g., laptops, notebooks, ultra-portables, and netbooks), server computers, and other computer systems, such as described herein with reference to FIG. 13 (e.g., server(s) 304). For example, the various aspects described herein below can be applied to desktop computers that utilize a touchscreen or some other touch-enabled device, such as a touch-enabled track pad or touch-enabled mouse.

The computing device architecture 1500 illustrated in FIG. 15 includes a processor 1502, memory components 1504, network connectivity components 1506, sensor components 1508, input/output components 1510, and power components 1512. In the illustrated configuration, the processor 1502 is in communication with the memory components 1504, the network connectivity components 1506, the sensor components 1508, the input/output (“I/O”) components 1510, and the power components 1512. Although no connections are shown between the individual components illustrated in FIG. 15, the components can interact to carry out device functions. In some configurations, the components are arranged so as to communicate via one or more busses (not shown).

The processor 1502 includes a central processing unit (“CPU”) configured to process data, execute computer-executable instructions of one or more application programs, and communicate with other components of the computing device architecture 1500 in order to perform various functionality described herein. The processor 1502 can be utilized to execute aspects of the software components presented herein. The processor 1502 can correspond to processor(s) 104, processor(s) 206, processor(s) 308, as described above in reference to FIGS. 1-3, respectively.

In some configurations, the processor 1502 includes a graphics processing unit (“GPU”) configured to accelerate operations performed by the CPU, including, but not limited to, operations performed by executing general-purpose scientific and/or engineering computing applications, as well as graphics-intensive computing applications such as high resolution video (e.g., 1520P, 1080P, and higher resolution), video games, three-dimensional (“3D”) modeling applications, and the like. In some configurations, the processor 1502 is configured to communicate with a discrete GPU (not shown). In any case, the CPU and GPU can be configured in accordance with a co-processing CPU/GPU computing model, wherein the sequential part of an application executes on the CPU and the computationally-intensive part is accelerated by the GPU.

In some configurations, the processor 1502 is, or is included in, a System-on-Chip (“SoC”) along with one or more of the other components described herein below. For example, the SoC can include the processor 1502, a GPU, one or more of the network connectivity components 1506, and one or more of the sensor components 1508. In some configurations, the processor 1502 is fabricated, in part, utilizing a Package-on-Package (“PoP”) integrated circuit packaging technique. The processor 1502 can be a single core or multi-core processor.

The processor 1502 can be created in accordance with an ARM architecture, available for license from ARM HOLDINGS of Cambridge, United Kingdom. Alternatively, the processor 1502 can be created in accordance with an x86 architecture, such as is available from INTEL CORPORATION of Mountain View, California and others. In some configurations, the processor 1502 is a SNAPDRAGON SoC, available from QUALCOMM of San Diego, Calif., a TEGRA SoC, available from NVIDIA of Santa Clara, Calif., a HUMMINGBIRD SoC, available from SAMSUNG of Seoul, South Korea, an Open Multimedia Application Platform (“OMAP”) SoC, available from TEXAS INSTRUMENTS of Dallas, Tex., a customized version of any of the above SoCs, or a proprietary SoC.

The memory components 1504 include a random access memory (“RAM”) 1514, a read-only memory (“ROM”) 1516, an integrated storage memory (“integrated storage”) 1518, and a removable storage memory (“removable storage”) 1520. In some configurations, the RAM 1514 or a portion thereof, the ROM 1516 or a portion thereof, and/or some combination the RAM 1514 and the ROM 1516 is integrated in the processor 1502. In some configurations, the ROM 1516 is configured to store a firmware, an operating system or a portion thereof (e.g., operating system kernel), and/or a bootloader to load an operating system kernel from the integrated storage 1518 and/or the removable storage 1520. The memory components 1504 can correspond to computer-readable media 106, computer-readable media 208, computer-readable media 310, as described above in reference to FIGS. 1-3, respectively.

The integrated storage 1518 can include a solid-state memory, a hard disk, or a combination of solid-state memory and a hard disk. The integrated storage 1518 can be soldered or otherwise connected to a logic board upon which the processor 1502 and other components described herein also can be connected. As such, the integrated storage 1518 is integrated in the computing device. The integrated storage 1518 is configured to store an operating system or portions thereof, application programs, data, and other software components described herein.

The removable storage 1520 can include a solid-state memory, a hard disk, or a combination of solid-state memory and a hard disk. In some configurations, the removable storage 1520 is provided in lieu of the integrated storage 1518. In other configurations, the removable storage 1520 is provided as additional optional storage. In some configurations, the removable storage 1520 is logically combined with the integrated storage 1518 such that the total available storage is made available as a total combined storage capacity. In some configurations, the total combined capacity of the integrated storage 1518 and the removable storage 1520 is shown to a user instead of separate storage capacities for the integrated storage 1518 and the removable storage 1520.

The removable storage 1520 is configured to be inserted into a removable storage memory slot (not shown) or other mechanism by which the removable storage 1520 is inserted and secured to facilitate a connection over which the removable storage 1520 can communicate with other components of the computing device, such as the processor 1502. The removable storage 1520 can be embodied in various memory card formats including, but not limited to, PC card, CompactFlash card, memory stick, secure digital (“SD”), miniSD, microSD, universal integrated circuit card (“UICC”) (e.g., a subscriber identity module (“SIM”) or universal SIM (“USIM”)), a proprietary format, or the like.

It can be understood that one or more of the memory components 1504 can store an operating system. According to various configurations, the operating system includes, but is not limited to, PALM WEBOS from Hewlett-Packard Company of Palo Alto, California, BLACKBERRY OS from Research In Motion Limited of Waterloo, Ontario, Canada, IOS from Apple Inc. of Cupertino, Calif., and ANDROID OS from Google Inc. of Mountain View, Calif. Other operating systems are contemplated.

The network connectivity components 1506 include a wireless wide area network component (“WWAN component”) 1522, a wireless local area network component (“WLAN component”) 1524, and a wireless personal area network component (“WPAN component”) 1526. The network connectivity components 1506 facilitate communications to and from the network 1527 or another network, which can be a WWAN, a WLAN, or a WPAN. Although only the network 1527 is illustrated, the network connectivity components 1506 can facilitate simultaneous communication with multiple networks, including the network 1527 of FIG. 15. For example, the network connectivity components 1506 can facilitate simultaneous communications with multiple networks via one or more of a WWAN, a WLAN, or a WPAN.

The network 1527 can be or can include a WWAN, such as a mobile telecommunications network utilizing one or more mobile telecommunications technologies to provide voice and/or data services to a computing device utilizing the computing device architecture 1500 via the WWAN component 1522. The mobile telecommunications technologies can include, but are not limited to, Global System for Mobile communications (“GSM”), Code Division Multiple Access (“CDMA”) ONE, CDMA2000, Universal Mobile Telecommunications System (“UMTS”), Long Term Evolution (“LTE”), and Worldwide Interoperability for Microwave Access (“WiMAX”). Moreover, the network 1527 can utilize various channel access methods (which can or cannot be used by the aforementioned standards) including, but not limited to, Time Division Multiple Access (“TDMA”), Frequency Division Multiple Access (“FDMA”), CDMA, wideband CDMA (“W-CDMA”), Orthogonal Frequency Division Multiplexing (“OFDM”), Space Division Multiple Access (“SDMA”), and the like. Data communications can be provided using General Packet Radio Service (“GPRS”), Enhanced Data rates for Global Evolution (“EDGE”), the High-Speed Packet Access (“HSPA”) protocol family including High-Speed Downlink Packet Access (“HSDPA”), Enhanced Uplink (“EUL”) or otherwise termed High-Speed Uplink Packet Access (“HSUPA”), Evolved HSPA (“HSPA+”), LTE, and various other current and future wireless data access standards. The network 1527 can be configured to provide voice and/or data communications with any combination of the above technologies. The network 104 can be configured to or adapted to provide voice and/or data communications in accordance with future generation technologies.

In some configurations, the WWAN component 1522 is configured to provide dual-multi-mode connectivity to the network 1527. For example, the WWAN component 1522 can be configured to provide connectivity to the network 1527, wherein the network 1527 provides service via GSM and UMTS technologies, or via some other combination of technologies. Alternatively, multiple WWAN components 1522 can be utilized to perform such functionality, and/or provide additional functionality to support other non-compatible technologies (i.e., incapable of being supported by a single WWAN component). The WWAN component 1522 can facilitate similar connectivity to multiple networks (e.g., a UMTS network and an LTE network).

The network 1527 can be a WLAN operating in accordance with one or more Institute of Electrical and Electronic Engineers (“IEEE”) 802.15 standards, such as IEEE 802.15a, 802.15b, 802.15g, 802.15n, and/or future 802.15 standard (referred to herein collectively as WI-FI). Draft 802.15 standards are also contemplated. In some configurations, the WLAN is implemented utilizing one or more wireless WI-FI access points. In some configurations, one or more of the wireless WI-FI access points are another computing device with connectivity to a WWAN that are functioning as a WI-FI hotspot. The WLAN component 1524 is configured to connect to the network 104 via the WI-FI access points. Such connections can be secured via various encryption technologies including, but not limited, WI-FI Protected Access (“WPA”), WPA2, Wired Equivalent Privacy (“WEP”), and the like.

The network 1527 can be a WPAN operating in accordance with Infrared Data Association (“IrDA”), BLUETOOTH, wireless Universal Serial Bus (“USB”), Z-Wave, ZIGBEE, or some other short-range wireless technology. In some configurations, the WPAN component 1526 is configured to facilitate communications with other devices, such as peripherals, computers, or other computing entities via the WPAN.

In at least one example, the sensor components 1508 can include a magnetometer 1528, an ambient light sensor 1530, a proximity sensor 1532, an accelerometer 1534, a gyroscope 1536, and a Global Positioning System sensor (“GPS sensor”) 1538. Additionally, the sensor components 1508 can include sensor(s) 108 as described above with reference to FIG. 1. It is contemplated that other sensors, such as, but not limited to, temperature sensors or shock detection sensors, also can be incorporated in the computing device architecture 1500.

The magnetometer 1528 is configured to measure the strength and direction of a magnetic field. In some configurations the magnetometer 1528 provides measurements to a compass application program stored within one of the memory components 1504 in order to provide a user with accurate directions in a frame of reference including the cardinal directions, north, south, east, and west. Similar measurements can be provided to a navigation application program that includes a compass component. Other uses of measurements obtained by the magnetometer 1528 are contemplated.

The ambient light sensor 1530 is configured to measure ambient light. In some configurations, the ambient light sensor 1530 provides measurements to an application program stored within one the memory components 1504 in order to automatically adjust the brightness of a display (described below) to compensate for low-light and high-light environments. Other uses of measurements obtained by the ambient light sensor 1530 are contemplated.

The proximity sensor 1532 is configured to determine the presence of an object or thing in proximity to the computing device without direct contact. In some configurations, the proximity sensor 1532 detects the presence of a user's body (e.g., the user's face) and provides this information to an application program stored within one of the memory components 1504 that utilizes the proximity information to enable or disable some functionality of the computing device. For example, a telephone application program can automatically disable a touchscreen (described below) in response to receiving the proximity information so that the user's face does not inadvertently end a call or enable/disable other functionality within the telephone application program during the call. Other uses of proximity as detected by the proximity sensor 1528 are contemplated.

The accelerometer 1534 is configured to measure proper acceleration. In some configurations, output from the accelerometer 1534 is used by an application program as an input mechanism to control some functionality of the application program. For example, the application program can be a video game in which a character, a portion thereof, or an object is moved or otherwise manipulated in response to input received via the accelerometer 1534. In some configurations, output from the accelerometer 1534 is provided to an application program for use in switching between landscape and portrait modes, calculating coordinate acceleration, or detecting a fall. Other uses of the accelerometer 1534 are contemplated.

The gyroscope 1536 is configured to measure and maintain orientation. In some configurations, output from the gyroscope 1536 is used by an application program as an input mechanism to control some functionality of the application program. For example, the gyroscope 1536 can be used for accurate recognition of movement within a 3D environment of a video game application or some other application. In some configurations, an application program utilizes output from the gyroscope 1536 and the accelerometer 1534 to enhance control of some functionality of the application program. Other uses of the gyroscope 1536 are contemplated.

The GPS sensor 1538 is configured to receive signals from GPS satellites for use in calculating a location. The location calculated by the GPS sensor 1538 can be used by any application program that requires or benefits from location information. For example, the location calculated by the GPS sensor 1538 can be used with a navigation application program to provide directions from the location to a destination or directions from the destination to the location. Moreover, the GPS sensor 1538 can be used to provide location information to an external location-based service, such as E1515 service. The GPS sensor 1538 can obtain location information generated via WI-FI, WIMAX, and/or cellular triangulation techniques utilizing one or more of the network connectivity components 1506 to aid the GPS sensor 1538 in obtaining a location fix. The GPS sensor 1538 can also be used in Assisted GPS (“A-GPS”) systems.

In at least one example, the I/O components 1510 can correspond to the input interface(s) 110 and/or output interface(s) 112, described above with reference to FIG. 1. Additionally and/or alternatively, the I/O components can include a display 1540, a touchscreen 1542, a data I/O interface component (“data I/O”) 1544, an audio I/O interface component (“audio I/O”) 1546, a video I/O interface component (“video I/O”) 1548, and a camera 1550. In some configurations, the display 1540 and the touchscreen 1542 are combined. In some configurations two or more of the data I/O component 1544, the audio I/O component 1546, and the video I/O component 1548 are combined. The I/O components 1510 can include discrete processors configured to support the various interface described below, or can include processing functionality built-in to the processor 1502.

The display 1540 is an output device configured to present information in a visual form. In particular, the display 1540 can present graphical user interface (“GUI”) elements, text, images, video, notifications, virtual buttons, virtual keyboards, messaging data, Internet content, device status, time, date, calendar data, preferences, map information, location information, and any other information that is capable of being presented in a visual form. In some configurations, the display 1540 is a liquid crystal display (“LCD”) utilizing any active or passive matrix technology and any backlighting technology (if used). In some configurations, the display 1540 is an organic light emitting diode (“OLED”) display. Other display types are contemplated.

In at least one example, the display 1540 can correspond to the hardware display surface 128. As described above, the hardware display surface 128 can be configured to graphically associate holographic user interfaces and other graphical elements with an object seen through the hardware display surface 128 or rendered objects displayed on the hardware display surface 128. Additional features associated with the hardware display device 128 are described above with reference to FIG. 1.

The touchscreen 1542, also referred to herein as a “touch-enabled screen,” is an input device configured to determine the presence and location of a touch. The touchscreen 1542 can be a resistive touchscreen, a capacitive touchscreen, a surface acoustic wave touchscreen, an infrared touchscreen, an optical imaging touchscreen, a dispersive signal touchscreen, an acoustic pulse recognition touchscreen, or can utilize any other touchscreen technology. In some configurations, the touchscreen 1542 is incorporated on top of the display 1540 as a transparent layer to enable a user to use one or more touches to interact with objects or other information presented on the display 1540. In other configurations, the touchscreen 1542 is a touch pad incorporated on a surface of the computing device that does not include the display 1540. For example, the computing device can have a touchscreen incorporated on top of the display 1540 and a touch pad on a surface opposite the display 1540.

In some configurations, the touchscreen 1542 is a single-touch touchscreen. In other configurations, the touchscreen 1542 is a multi-touch touchscreen. In some configurations, the touchscreen 1542 is configured to determine discrete touches, single touch gestures, and/or multi-touch gestures. These are collectively referred to herein as gestures for convenience. Several gestures will now be described. It should be understood that these gestures are illustrative and are not intended to limit the scope of the appended claims. Moreover, the described gestures, additional gestures, and/or alternative gestures can be implemented in software for use with the touchscreen 1542. As such, a developer can create gestures that are specific to a particular application program.

In some configurations, the touchscreen 1542 supports a tap gesture in which a user taps the touchscreen 1542 once on an item presented on the display 1540. The tap gesture can be used to perform various functions including, but not limited to, opening or launching whatever the user taps. In some configurations, the touchscreen 1542 supports a double tap gesture in which a user taps the touchscreen 1542 twice on an item presented on the display 1540. The double tap gesture can used to perform various functions including, but not limited to, zooming in or zooming out in stages. In some configurations, the touchscreen 1542 supports a tap and hold gesture in which a user taps the touchscreen 1542 and maintains contact for at least a pre-defined time. The tap and hold gesture can be used to perform various functions including, but not limited to, opening a context-specific menu.

In some configurations, the touchscreen 1542 supports a pan gesture in which a user places a finger on the touchscreen 1542 and maintains contact with the touchscreen 1542 while moving the finger on the touchscreen 1542. The pan gesture can be used to perform various functions including, but not limited to, moving through screens, images, or menus at a controlled rate. Multiple finger pan gestures are also contemplated. In some configurations, the touchscreen 1542 supports a flick gesture in which a user swipes a finger in the direction the user wants the screen to move. The flick gesture can be used to perform various functions including, but not limited to, scrolling horizontally or vertically through menus or pages. In some configurations, the touchscreen 1542 supports a pinch and stretch gesture in which a user makes a pinching motion with two fingers (e.g., thumb and forefinger) on the touchscreen 1542 or moves the two fingers apart. The pinch and stretch gesture can be used to perform various functions including, but not limited to, zooming gradually in or out of a web site, map, or picture.

Although the above gestures have been described with reference to the use of one or more fingers for performing the gestures, other appendages such as toes or objects such as styluses can be used to interact with the touchscreen 1542. As such, the above gestures should be understood as being illustrative and should not be construed as being limited in any way.

The data I/O interface component 1544 is configured to facilitate input of data to the computing device and output of data from the computing device. In some configurations, the data I/O interface component 1544 includes a connector configured to provide wired connectivity between the computing device and a computer system, for example, for synchronization operation purposes. The connector can be a proprietary connector or a standardized connector such as USB, micro-USB, mini-USB, or the like. In some configurations, the connector is a dock connector for docking the computing device with another device such as a docking station, audio device (e.g., a digital music player), or video device.

The audio I/O interface component 1546 is configured to provide audio input and/or output capabilities to the computing device. In some configurations, the audio I/O interface component 1546 includes a microphone configured to collect audio signals. In some configurations, the audio I/O interface component 1546 includes a headphone jack configured to provide connectivity for headphones or other external speakers. In some configurations, the audio I/O interface component 1546 includes a speaker for the output of audio signals. In some configurations, the audio I/O interface component 1546 includes an optical audio cable out.

The video I/O interface component 1548 is configured to provide video input and/or output capabilities to the computing device. In some configurations, the video I/O interface component 1548 includes a video connector configured to receive video as input from another device (e.g., a video media player such as a DVD or BLURAY player) or send video as output to another device (e.g., a monitor, a television, or some other external display). In some configurations, the video I/O interface component 1548 includes a High-Definition Multimedia Interface (“HDMI”), mini-HDMI, micro-HDMI, DisplayPort, or proprietary connector to input/output video content. In some configurations, the video I/O interface component 1548 or portions thereof is combined with the audio I/O interface component 1546 or portions thereof

The camera 1550 can be configured to capture still images and/or video. The camera 1550 can utilize a charge coupled device (“CCD”) or a complementary metal oxide semiconductor (“CMOS”) image sensor to capture images. In some configurations, the camera 1550 includes a flash to aid in taking pictures in low-light environments. Settings for the camera 1550 can be implemented as hardware or software buttons.

Although not illustrated, one or more hardware buttons can also be included in the computing device architecture 1500. The hardware buttons can be used for controlling some operational aspect of the computing device. The hardware buttons can be dedicated buttons or multi-use buttons. The hardware buttons can be mechanical or sensor-based.

The illustrated power components 1512 include one or more batteries 1552, which can be connected to a battery gauge 1554. The batteries 1552 can be rechargeable or disposable. Rechargeable battery types include, but are not limited to, lithium polymer, lithium ion, nickel cadmium, and nickel metal hydride. Each of the batteries 1552 can be made of one or more cells.

The battery gauge 1554 can be configured to measure battery parameters such as current, voltage, and temperature. In some configurations, the battery gauge 1554 is configured to measure the effect of a battery's discharge rate, temperature, age and other factors to predict remaining life within a certain percentage of error. In some configurations, the battery gauge 1554 provides measurements to an application program that is configured to utilize the measurements to present useful power management data to a user. Power management data can include one or more of a percentage of battery used, a percentage of battery remaining, a battery condition, a remaining time, a remaining capacity (e.g., in watt hours), a current draw, and a voltage.

The power components 1512 can also include a power connector, which can be combined with one or more of the aforementioned I/O components 1510. The power components 1512 can interface with an external power system or charging equipment via a power I/O component.

### EXAMPLE CLAUSES

The disclosure presented herein can be considered in view of the following clauses.

A. A system comprising: a sensor to generate sensor data associated with measurements of a physiological attribute of a user; and a device corresponding to the user, the device including: one or more processors; memory; a plurality of applications stored in the memory and executable by the one or more processors to perform functionalities associated with the plurality of applications, each application of the plurality of applications being associated with a functionality of the functionalities; one or more modules stored in the memory and executable by the one or more processors to perform operations comprising: determining an occurrence of an event based at least in part on the sensor data, the event corresponding to a confused mental state of the user; determining contextual data associated with the event, the contextual data identifying at least a first application of the plurality of applications being executed at a time corresponding to the occurrence of the event; accessing, based at least in part on the contextual data, content data including at least one of a tip, a tutorial, or other resource for mitigating the confused mental state of the user; and causing the content data to be presented via the device.

B. A system as paragraph A recites wherein, the contextual data further identifies at least one of a function or a feature associated with the application that the user interacted with at a substantially same time as the time corresponding to the occurrence of the event.

C. A system as paragraph A or B recites wherein, the contextual data further identifies one or more actions that preceded the occurrence of the event.

D. A system as paragraph C recites, wherein at least one action of the one or more actions is associated with a second application of the plurality of applications.

E. A system as any of paragraphs A-D recite, the operations further comprising, prior to causing the content to be presented via the device: sending a request to the first application for the content data; and receiving the content data from the first application.

F. A system as any of paragraphs A-E recite, the operations further comprising, prior to causing the content to be presented via the device, sending a request to the first application to cause the content data to be presented via the device.

G. A system as any of paragraphs A-F recite, the operations further comprising providing a first interface configured to receive state data and transmit event data including an indication of the occurrence of the event to an operating system associated with the system, the state data being determined based at least in part on the sensor data and indicating a likelihood that the user is confused.

H. A system as paragraph G recites, the operations further comprising providing a second interface configured to receive the event data and transmit notification data to a module of the one or more modules, the notification data including instructions to cause the content to be presented via the device.

I. A system as any of paragraphs A-H recite, the device further comprising a display to provide a real-world view of an object associated with first application through the display and a rendering of a graphical representation of the content data.

J. A computer-implemented method for causing contextual content to be presented via an output interface of a device, the method comprising: receiving sensor data from a sensor, the sensor data being associated with a measurement of a physiological attribute of a user; determining an occurrence of an event based at least in part on the sensor data, the event corresponding to a confused mental state of the user; determining contextual data associated with the event, the contextual data identifying at least an application being executed at a time corresponding to the occurrence of the event; accessing, based at least in part on the contextual data, content data for mitigating the confused mental state of the user; and causing the content data to be presented via the output interface of the device.

K. A computer-implemented method as paragraph J recites, wherein the content data comprises at least one of a tip, a tutorial, or other resource for mitigating the confused mental state of the user.

L. A computer-implemented method as paragraph J or K recites, wherein: the contextual data comprises a series of events; and the computer-implemented method further comprises generating the content data based at least in part on initiating arbitrary call execution to create custom handlers based on the series of events.

M. A computer-implemented method as any of paragraphs J-L recite, wherein the content data is accessed from a repository of previously defined content data.

N. A computer-implemented method as any of paragraphs J-M recite, wherein determining the occurrence of the event is based at least in part on a machine learning data model trained to determine the confused mental state of the user based at least in part on the measurement.

O. A computer-implemented method as paragraph N recites, further comprising: presenting a feedback mechanism associated with the content data; receiving feedback data via the feedback mechanism; and updating the machine learning data model based at least in part on the feedback data.

P. A computer-implemented method as any of paragraphs J-0 recite, wherein: causing the content data to be presented comprises causing a graphical representation of the content data to be presented via a display of the device; and a position of the graphical representation is based at least in part on the contextual data.

Q. A computer-implemented method as any of claims J-P recite, wherein causing the content data to be presented comprises causing a spoken representation of the content data to be output via speakers associated with the device.

R. One or more computer-readable media encoded with instructions that, when executed by a processor, configure a computer to perform a method as any of paragraphs J-Q recite.

S. A device comprising one or more processors and one or more computer readable media encoded with instructions that, when executed by the one or more processors, configure a computer to perform a computer-implemented method as any of paragraphs J-Q recite.

T. A computer-implemented method for causing contextual content to be presented via an output interface of a device, the method comprising: means for receiving sensor data from a sensor, the sensor data being associated with a measurement of a physiological attribute of a user; means for determining an occurrence of an event based at least in part on the sensor data, the event corresponding to a confused mental state of the user; means for determining contextual data associated with the event, the contextual data identifying at least an application being executed at a time corresponding to the occurrence of the event; means for accessing, based at least in part on the contextual data, content data for mitigating the confused mental state of the user; and means for causing the content data to be presented via the output interface of the device.

U. A computer-implemented method as paragraph T recites, wherein the content data comprises at least one of a tip, a tutorial, or other resource for mitigating the confused mental state of the user.

V. A computer-implemented method as paragraph T or U recites, wherein: the contextual data comprises a series of events; and the computer-implemented method further comprises means for generating the content data based at least in part on initiating arbitrary call execution to create custom handlers based on the series of events.

W. A computer-implemented method as any of paragraphs T-V recite, wherein the content data is accessed from a repository of previously defined content data.

X. A computer-implemented method as any of paragraphs T-W recite, wherein determining the occurrence of the event is based at least in part on a machine learning data model trained to determine the confused mental state of the user based at least in part on the measurement.

Y. A computer-implemented method as paragraph X recites, further comprising: means for presenting a feedback mechanism associated with the content data; means for receiving feedback data via the feedback mechanism; and means for updating the machine learning data model based at least in part on the feedback data.

Z. A computer-implemented method as any of paragraphs T-Y recite, wherein: causing the content data to be presented comprises causing a graphical representation of the content data to be presented via a display of the device; and a position of the graphical representation is based at least in part on the contextual data.

AA. A computer-implemented method as any of claims T-Z recite, wherein causing the content data to be presented comprises causing a spoken representation of the content data to be output via speakers associated with the device.

AB. A computer-readable medium storing computer-executable instructions that, when executed, cause one or more processors to perform acts comprising: receiving, from a first sensor, first sensor data associated with a first measurement of a first physiological attribute of a user; determining an occurrence of an event based at least in part on the first sensor data, the event corresponding to a confused mental state of the user; determining contextual data associated with the event, the contextual data identifying an application being executed at a time corresponding to the occurrence of the event and at least one of a feature of the application or a function of the application being executed at a time corresponding to the occurrence of the event; accessing, based at least in part on the contextual data, content data including at least one of a tip, a tutorial, or other resource for mitigating the confused mental state of the user; and causing the content data to be presented via a device corresponding to the user.

AC. A computer-readable medium as paragraph AB recites wherein, determining the occurrence of the event is further based at least in part on: determining a first value representative of a likelihood that the user is confused based at least in part on the first sensor data; receiving, from a second sensor, second sensor data associated with a second measurement of a first physiological attribute of the user; determining a second value representative of a likelihood that the user is confused based at least in part on the second sensor data; and ranking the first value and the second value to determine an order.

AD. A computer-readable medium as paragraph AC recites wherein: determining the occurrence of the event is further based at least in part on applying a trained data model to the first value and the second value; the trained data model associates a first weight with the first value and a second weight with the second value; and the first weight and the second weight are determined based at least in part on the order.

Although the subject matter has been described in language specific to structural features and/or methodological acts, it is to be understood that the subject matter defined in the appended claims is not necessarily limited to the specific features or acts described. Rather, the specific features and acts are described as illustrative forms of implementing the claims.

Conditional language such as, among others, “can,” “could,” “might” or “can,” unless specifically stated otherwise, are understood within the context to present that certain examples include, while other examples do not necessarily include, certain features, elements and/or steps. Thus, such conditional language is not generally intended to imply that certain features, elements and/or steps are in any way required for one or more examples or that one or more examples necessarily include logic for deciding, with or without input or prompting, whether certain features, elements and/or steps are included or are to be performed in any particular example. Conjunctive language such as the phrase “at least one of X, Y or Z,” unless specifically stated otherwise, is to be understood to present that an item, term, etc. can be either X, Y, or Z, or a combination thereof.

What is claimed is:

1. A system comprising:
a sensor to generate sensor data associated with measurements of a physiological attribute of a user; and
a device corresponding to the user, the device including:
one or more processors;
memory;
a plurality of applications stored in the memory and executable by the one or more processors to perform functionalities associated with the plurality of applications, each application of the plurality of applications being associated with a functionality of the functionalities;
one or more modules stored in the memory and executable by the one or more processors to perform operations comprising:
determining an occurrence of an event based at least in part on the sensor data, the event corresponding to a confused mental state of the user;
determining contextual data associated with the event, the contextual data identifying at least a first application of the plurality of applications being executed at a time corresponding to the occurrence of the event;
accessing, based at least in part on the contextual data, content data including at least one of a tip, a tutorial, or other resource for mitigating the confused mental state of the user; and
causing the content data to be presented via the device.

2. A system as claim 1 recites, wherein the contextual data further identifies at least one of a function or a feature associated with the application that the user interacted with at a substantially same time as the time corresponding to the occurrence of the event.

3. A system as claim 1 recites wherein, the contextual data further identifies one or more actions that preceded the occurrence of the event.

4. A system as claim 3 recites, wherein at least one action of the one or more actions is associated with a second application of the plurality of applications.

5. A system as claim 1 recites, the operations further comprising, prior to causing the content to be presented via the device:
sending a request to the first application for the content data; and
receiving the content data from the first application.

6. A system as claim 1 recites, the operations further comprising, prior to causing the content to be presented via the device, sending a request to the first application to cause the content data to be presented via the device.

7. A system as claim 1 recites, the operations further comprising providing a first interface configured to receive state data and transmit event data including an indication of the occurrence of the event to an operating system associated with the system, the state data being determined based at least in part on the sensor data and indicating a likelihood that the user is confused.

8. A system as claim 7 recites, the operations further comprising providing a second interface configured to receive the event data and transmit notification data to a module of the one or more modules, the notification data including instructions to cause the content to be presented via the device.

9. A system as claim 1 recites, the device further comprising a display to provide a real-world view of an object associated with first application through the display and a rendering of a graphical representation of the content data.

10. A computer-implemented method for causing contextual content to be presented via an output interface of a device, the method comprising:
receiving sensor data from a sensor, the sensor data being associated with a measurement of a physiological attribute of a user;
determining an occurrence of an event based at least in part on the sensor data, the event corresponding to a confused mental state of the user;
determining contextual data associated with the event, the contextual data identifying at least an application being executed at a time corresponding to the occurrence of the event;
accessing, based at least in part on the contextual data, content data for mitigating the confused mental state of the user; and
causing the content data to be presented via the output interface of the device.

11. A computer-implemented method as claim 10 recites, wherein the content data comprises at least one of a tip, a tutorial, or other resource for mitigating the confused mental state of the user.

12. A computer-implemented method as claim 10 recites, wherein:
the contextual data comprises a series of events; and
the computer-implemented method further comprises generating the content data based at least in part on initiating arbitrary call execution to create custom handlers based on the series of events.

13. A computer-implemented method as claim 10 recites, wherein the content data is accessed from a repository of previously defined content data.

14. A computer-implemented method as claim 10 recites, wherein determining the occurrence of the event is based at least in part on a machine learning data model trained to determine the confused mental state of the user based at least in part on the measurement.

15. A computer-implemented method as claim 14 recites, further comprising:
presenting a feedback mechanism associated with the content data;
receiving feedback data via the feedback mechanism; and
updating the machine learning data model based at least in part on the feedback data.

16. A computer-implemented method as claim 10 recites, wherein:
causing the content data to be presented comprises causing a graphical representation of the content data to be presented via a display of the device; and
a position of the graphical representation is based at least in part on the contextual data.

17. A computer-implemented method as claim 10 recites, wherein causing the content data to be presented comprises causing a spoken representation of the content data to be output via speakers associated with the device.

18. A computer-readable medium storing computer-executable instructions that, when executed, cause one or more processors to perform acts comprising:
receiving, from a first sensor, first sensor data associated with a first measurement of a first physiological attribute of a user;
determining an occurrence of an event based at least in part on the first sensor data, the event corresponding to a confused mental state of the user;
determining contextual data associated with the event, the contextual data identifying an application being executed at a time corresponding to the occurrence of the event and at least one of a feature of the application or a function of the application being executed at a time corresponding to the occurrence of the event;
accessing, based at least in part on the contextual data, content data including at least one of a tip, a tutorial, or other resource for mitigating the confused mental state of the user; and
causing the content data to be presented via a device corresponding to the user.

19. A computer-readable medium as claim 18 recites wherein, determining the occurrence of the event is further based at least in part on:
determining a first value representative of a likelihood that the user is confused based at least in part on the first sensor data;
receiving, from a second sensor, second sensor data associated with a second measurement of a first physiological attribute of the user;
determining a second value representative of a likelihood that the user is confused based at least in part on the second sensor data; and
ranking the first value and the second value to determine an order.

20. A computer-readable medium as claim 19 recites wherein:
determining the occurrence of the event is further based at least in part on applying a trained data model to the first value and the second value;
the trained data model associates a first weight with the first value and a second weight with the second value;
and the first weight and the second weight are determined based at least in part on the order.
